(19) United States
(12) Patent Application Publication
(10) Pub. No.: US 2025/0382239 A1
(43) Pub. Date: Dec. 18, 2025

(54) COMPOSITIONS FOR ENHANCING NITROGEN FERTILIZERS BY INCORPORATING ANTI-OXIDANT MOIETIES AND METHODS FOR USE THEREOF

(71) Applicant: Verdesian Life Sciences U.S., LLC, Cary, NC (US)

(72) Inventors: Ashish Arun Pandya, Morrisville, NC (US); Kuide Qin, Chapel Hill, NC (US); Gary Orr, Pittsboro, NC (US); Sandra Paa, Durham, NC (US)

(21) Appl. No.: 19/109,296

(22) PCT Filed: Sep. 28, 2023
(86) PCT No.: PCT/US2023/033984

§ 371 Date: Mar. 6, 2025

Related U.S. Application Data
(60) Provisional application No. 63/412,723, filed on Oct. 3, 2022.

(51) Int. Cl. C05C 9/00; C05G 3/90; C05G 5/12

(52) U.S. Cl. CPC C05C 9/00; C05G 3/90; C05G 5/12

(57) ABSTRACT

The present invention relates to urease inhibitor compositions containing tert-butylhydroquinone and optionally an additive component to enhance the inhibitory properties of tert-butylhydroquinone. Further described are uses of these compositions in agriculture to increase nutrient uptake and inhibit urease enzyme activity.

### FIELD OF THE INVENTION

The presently disclosed subject matter is directed to compositions containing tert-butylhydroquinone. Further described are uses of these compositions in agriculture to increase nutrient uptake and inhibit urease enzyme activity.

### BACKGROUND

Nitrogen is an essential plant nutrient thought to be important for adequate and strong foliage. Urea provides a large nitrogen content and is the dominant nitrogen fertilizer. In the presence of soil moisture, natural or synthetic ureas are converted to ammonium ion, which is then available for plant uptake. Ammonium can be further converted by bacteria in soil to nitrate through a nitrification process. Nitrate is also available for plant uptake. However, the urea usage efficiency by plants is low. Although urea-containing fertilizers are currently being used on a scale of millions of tons per year globally and are the primary fertilizer being used, about 30% of the fertilizer being applied never reaches the intended target zone (roots).

In practice, nitrogen fertilizer is often just applied once at the beginning of the growing season. Typically, nitrogen fertilizer is formulated as dry granules, prills, or as fluids made up of urea alone or mixed with ammonium nitrate as UAN (a mixture containing urea, ammonium nitrate, and water). Urea is also present in animal manure. These forms of urea have a significant disadvantage in that they undergo rapid decomposition and generate ammonia gas when applied to soil. This is due to the presence of urease enzyme in soils, which reacts with urea to produce ammonium bicarbonate and ammonia. This general set of processes is known in the art as volatilization. Volatilization results in decreased efficiency of nitrogen fertilizer use, lower yields, plant symptoms of nitrogen deficiency, undesirable odors, and potentially harmful ammonia gas concentrations. In addition, the generated ammonia can also be converted to nitrate by bacteria in the soil, which is called nitrification. Excessive nitrate can be converted into nitric oxide or nitrous oxide by certain types of bacteria in the soil, which is called denitrification.

Urease enzyme inhibitors have been developed that are capable of delaying degradation of nitrogen fertilizer, thereby reducing losses of nitrogenous degradation products that would otherwise occur in the absence of these inhibitors. The use of urease enzyme inhibitors in combination with nitrogen fertilizers tends to increase the amount of time the nitrogen source remains in the soil and available for absorption by the plants, which then increases the effectiveness of the fertilizer, positively impacting crop yield and quality. However, problems relating to cost, safety, convenience, and stability have limited the use of these types of inhibitors. Currently, the Agrotain® line of products contain urease enzyme inhibitor N-(n-butyl)thiophosphoric triamide (NBPT) and are often used for improving nitrogen fertilizer availability and minimize ammonia volatilization. However, products such as Agrotain® exhibit various drawbacks including its chemical stability, and potential to interfere with nitrogen uptake and assimilation in target crops (Zanin L, Tomasi N, Zamboni A, Varanini Z and Pinton R (2015) The Urease Inhibitor NBPT Negatively Affects DUR3-mediated Uptake and Assimilation of Urea in Maize Roots. Front. Plant Sci. 6:1007; Zanin L, Venuti S, Tomasi N, Zamboni A, De Brito Francisco R M, Varanini Z and Pinton R (2016) Short-Term Treatment with the Urease Inhibitor N-(n-Butyl) Thiophosphoric Triamide (NBPT) Alters Urea Assimilation and Modulates Transcriptional Profiles of Genes Involved in Primary and Secondary Metabolism in Maize Seedlings. Front. Plant Sci. 7:845). Therefore, finding urease inhibitors that are stable and safe for the environment and animals as well as non-toxic to crops would be highly desirable.

Thus, despite the continuous ongoing research efforts to improve upon existing products, there still remains a significant need in the art for developing better methods for urease inhibition and compositions that contain urease inhibitors which provide good stability while being able to efficiently control enzyme-induced urea decomposition.

### SUMMARY OF THE INVENTION

In one aspect, the subject matter described herein is directed to a method of inhibiting urease enzyme activity comprising applying a urease inhibitor composition to the soil, wherein the urease inhibitor composition contains tert-butylhydroquinone and an organic solvent.

In one aspect, the subject matter described herein is directed to a method of fertilizing soil and/or improving plant growth and/or health comprising contacting a urease inhibitor composition with the soil, wherein the urease inhibitor composition contains tert-butylhydroquinone and an organic solvent. In another aspect, the organic solvent is selected from an aromatic solvent, a sulfoxide, a green solvent, a safe solvent, or a combination thereof.

In one aspect, the subject matter described herein is directed to an agricultural composition comprising a urease inhibitor composition that contains tert-butylhydroquinone and an organic solvent; and a solid urea-containing fertilizer, wherein the surface of the urea-containing fertilizer is coated with the urease inhibitor composition.

In one aspect, the subject matter described herein is directed to an agricultural composition comprising a urease inhibitor composition; and a solid urea-containing fertilizer, wherein the urease inhibitor composition comprises tert-butylhydroquinone; and an organic solvent, and wherein the surface of the urea-containing fertilizer is coated with the urease inhibitor composition.

In one aspect, the subject matter described herein is directed to a method for preparing the disclosed agricultural composition, the method comprising applying to the surface of the solid urea-containing fertilizer a urease inhibitor composition in the form of a liquid or dispersion, thereby coating the solid urea-containing fertilizer, wherein the urease inhibitor composition comprises tert-butylhydroquinone and an organic solvent.

In one aspect, the subject matter described herein is directed to a urease inhibitor composition comprising tert-butylhydroquinone; an additive selected from an α,β-unsaturated carbonyl system-containing additive, an acid-containing additive, an ester-containing additive, an aromatic additive, a glycol-containing additive; and an organic solvent, wherein tert-butylhydroquinone and the additive component are present in synergistic amounts.

### BRIEF DESCRIPTION OF THE DRAWINGS

FIG. 1 is a bar graph showing the concentration of N—NH₄⁺, N—NO₃⁻ and total inorganic N (N—NH₄⁺+N—NO₃⁻) at the end of the experiment. Lowercase letters inside the bars indicate significant N—NH₄⁺ differences (p<0.005) between treatments, while outside of the bars indicate significant N—NO₃⁻ differences. Uppercase letters on top of the bars indicate significant differences of total inorganic N between treatments; and

FIG. 2 is a bar graph showing the soil pH at the end of the experiment. Lowercase letters indicate significant differences (p<0.005) between treatments; and

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains, having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

As mentioned above, urea is one of the major nitrogen fertilizers that is widely used in agriculture production. It is believed that up to 40% of the nitrogen applied as urea can be lost if applied incorrectly, because after it is applied in the field it can react with water through the urease enzyme to form ammonium carbonate. Ammonium carbonate is unstable and breaks down into carbon dioxide and ammonia, which can be volatized and lost to the air. The losses can be substantial and are dependent on a number of factors such as soil pH, soil temperature, soil moisture, cation exchange capacity of the soil, and soil organic matter content.

Many methods for controlling volatile nitrogen losses from urea have been developed or proposed, including the application of metal salts of copper and zinc, boron compounds, organic urease inhibitors, acid coatings, polymer coatings, and reaction of urea with aldehydes to form reaction adducts. For example, N-(butyl) thiophosphoric acid triamide (NBPT) is one of the most known urease inhibitors in agriculture worldwide and is the active ingredient in the Agrotain® product line. However, the compound itself is thermally unstable and decomposes when in contact with water and acid. Once decomposed, it is not effective in providing the desired inhibitory effects on the urease enzyme. Thus, discovering and/or developing new classes of urease inhibitors, compositions and/or formulations that exhibit improved chemical/thermal stability, are less prone to decomposition, and more environmentally friendly would be of great value.

Advantageously, the compositions and methods described herein have been shown to provide desirable properties for the use of such urease inhibitors in agriculture, particularly when formulated together with certain additive components. Specifically, when combining urease inhibitor tert-butylhydroquinone (tBHQ) with additive components beneficial properties were observed such as, but not limited to, extended thermal/chemical stability, increased shelf life, reduced application rate, ease of handling, extended/prolonged effect of urease inhibition, as well as acceptable environmental and toxicology profiles. The additive components disclosed herein range over a wider variety of different chemical structure classes and the observed beneficial properties were observed when both agents (i.e., tBHQ and additive component) were present. In some embodiments, the agent was present in synergistically effective amounts.

Thus, the compositions disclosed herein not only contribute to an increased availability of plant nutrients by inhibiting urease enzyme activity, but also extend the longevity of their performance as being efficient urease inhibitors due to their beneficial properties mentioned above.

### I. DEFINITIONS

As used herein, the term “aromatic ring system” refers to ring systems that contain at least one heteroaryl ring and/or at least one aryl ring.

As used herein, the term “heteroaryl” refers to a radical that comprises at least a five-membered or six-membered unsaturated and conjugated aromatic ring containing at least two ring carbon atoms and one to four ring heteroatoms selected from nitrogen, oxygen, and/or sulfur. Such heteroaryl radicals are often alternatively termed “heteroaromatic” by those of skill in the art. In some embodiments, the heteroaryl radicals have from two to twelve carbon atoms, or alternatively four to five carbon atoms in the heteroaryl ring. Examples include, but are not limited to, pyridinyl, pyrimidinyl, pyrazinyl, pyrrolyl, furanyl, tetrazolyl, isoxazolyl, oxadiazolyl, benzothiophenyl, benzofuranyl, quinolinyl, isoquinolinyl and the like.

As used herein, the term “aryl” refers to a radical comprising at least one unsaturated and conjugated six-membered ring analogous to the six-membered ring of benzene. Aryl radicals having such unsaturated and conjugated rings are also known to those of skill in the art as “aromatic” radicals. Preferred aryl radicals have 6 to 12 ring carbons. Aryl radicals include, but are not limited to, aromatic radicals comprising phenyl and naphthyl ring radicals.

As used herein, the term “substituted” refers to a moiety (such as heteroaryl, aryl, alkyl, and/or alkenyl), wherein the moiety is bonded to one or more additional organic or inorganic substituent radicals. In some embodiments, the substituted moiety comprises 1, 2, 3, 4, or 5 additional substituent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as heteroaryl, aryl, alkenyl, and/or alkyl) that is not bonded to one or more additional organic or inorganic substituent radicals as described above, meaning that such a moiety is only substituted with hydrogens.

As used herein, the term “halo,” “halogen,” or “halide” refers to a fluoro, chloro, bromo, or iodo atom or ion.

As used herein, the term “alkoxy” or “alkoxide” refers to an alkyl radical bound through a single, terminal ether linkage; that is, an “alkoxy” group can be defined as OR where R is alkyl as defined above. Examples include, but are not limited to, methoxy, ethoxy, n-propoxy, iso-propoxy, n-butoxy, t-butoxy, iso-butoxy and the like.

As used herein, the term “substituted alkoxy” refers to an alkoxy radical as defined above having one, two, or more additional organic or inorganic substituent radicals bound to the alkyl radical. Suitable organic and inorganic substituent radicals include, but are not limited to, hydroxyl, cycloalkyl, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, thiohaloalkyl, alkoxy, substituted alkoxy, or haloalkoxy. When the alkyl of the alkoxy is bonded thereon with more than one substituent radical, then the substituent radicals may be the same or different.

As used herein, the term “amino” refers to a substituted or unsubstituted trivalent nitrogen-containing radical or group that is structurally related to ammonia (NH₃) by the substitution of one or more of the hydrogen atoms of ammonia by a substituent radical.

As used herein, the term “mono-substituted amino” refers to an amino substituted with one radical selected from alkyl, substituted alkyl, or arylalkyl, wherein the terms have the same definitions found herein.

As used herein, the term “di-substituted amino” refers to an amino substituted with two radicals that may be the same or different selected from aryl, substituted aryl, alkyl, substituted alkyl or arylalkyl, wherein the terms have the same definitions as disclosed herein. Examples include, but are not limited to, dimethylamino, methylethylamino, diethylamino and the like. The two substituent radicals present may be the same or different.

As used herein, the term “haloalkyl” refers to an alkyl radical, as defined above, substituted with one or more halogens, such as fluorine, chlorine, bromine, or iodine, preferably fluorine. Examples include, but are not limited to, trifluoromethyl, pentafluoroethyl and the like.

As used herein, the term “haloalkoxy” refers to a haloalkyl, as defined above, that is directly bonded to oxygen to form trifluoromethoxy, pentafluoroethoxy and the like.

As used herein, the term “acyl” denotes a radical containing a carbonyl (—C(O)R group) wherein the R group is hydrogen or has 1 to 8 carbons. Examples include, but are not limited to, formyl, acetyl, propionyl, butanoyl, iso-butanoyl, pentanoyl, hexanoyl, heptanoyl, benzoyl and the like.

As used herein, the term “acyloxy” refers to a radical containing a carboxyl (—O—C(O)—R) group wherein the R group comprises hydrogen or 1 to 8 carbons. Examples include, but are not limited to, acetyloxy, propionyloxy, butanoyloxy, iso-butanoyloxy, benzoyloxy and the like.

As used herein, the term “alkyl group” refers a saturated hydrocarbon radical containing 1 to 12, 1 to 8, 1 to 6, 1 to 4, or 5 to 8 carbons. In some instances, the alkyl group refers to a saturated hydrocarbon radical containing more than 8 carbons. An alkyl group is structurally similar to a noncyclic alkane compound modified by the removal of one hydrogen from the noncyclic alkane, and the substitution therefore of a non-hydrogen group or radical. Alkyl group radicals can be branched or unbranched. Lower alkyl group radicals have 1 to 4 carbon atoms. Higher alkyl group radicals have 5 to 8 carbon atoms. Examples of alkyl, lower alkyl, and higher alkyl group radicals include, but are not limited to, methyl, ethyl, n-propyl, isopropyl, n-butyl, sec-butyl, t-butyl, amyl, t-amyl, n-pentyl, n-hexyl, i-octyl and like radicals.

As used herein, the term “alkenyl group” refers an unsaturated hydrocarbon radical containing 2 to 8, 2 to 6, 2 to 4, or 5 to 8 carbons and at least one carbon-carbon double bond. In some instances, the alkenyl group refers to an unsaturated hydrocarbon radical that contains more than 8 carbons. The unsaturated hydrocarbon radical is similar to an alkyl radical, as defined above, that also comprises at least one carbon-carbon double bond. Examples include, but are not limited to, vinyl, allyl, 2-butenyl, 3-butenyl, 2-pentenyl, 3-pentenyl, 4-pentenyl, 2-hexenyl, 3-hexenyl, 4-hexenyl, 5-hexanyl, 2-heptenyl, 3-heptenyl, 4-heptenyl, 5-heptenyl, 6-heptenyl and the like. The term “alkenyl” includes dienes and trienes of straight and branch chains.

As used herein, the term “stereoisomers” refers to isomers that have the same composition (that is, the same parts) but that differ in the orientation of those parts in space. There are two kinds of stereoisomers: enantiomers and diastereomers.

As used herein, the term “enantiomeric excess” (ee) is a measurement of purity used for chiral substances to describe the degree of a sample that contains one enantiomer in greater amount than the other. A racemic mixture has an ee of 0% while a single completely pure enantiomer has an ee of 100%.

As used herein, the term “diastereomeric excess” (de) is a measurement of purity used for chiral substances to describe the degree of a sample that contains one diastereomer in greater amount than the other. A racemic mixture has a de of 0% while a single completely pure diastereomer has a de of 100%.

As used herein, the term “urease inhibitor” refers to a property of a compound to inhibit the activity of urease enzymes. The inhibition can be quantified as described elsewhere herein.

As used herein, the term “thermal stability” refers to the stability of a substance when exposed to a thermal stimuli over a given period of time. Examples of thermal stimuli include, but are not limited to, heat generated from an electrical source and/or heat generated from the sun.

As used herein, the term “chemical stability” refers to the resistance of a substance to structurally change when exposed to an external action such as air (which can lead to oxidation), light (e.g., sunlight), moisture/humidity (from water), heat (from the sun), and/or chemical agents. Exemplary chemical agents include, but are not limited to, any organic or inorganic substance that can degrade the structural integrity of the compound of interest (e.g., tBHQ).

As used herein, the term “effective amount” refers to an amount of a urease inhibitor composition and/or the amount of each component in the urease inhibitor composition (i.e., tBHQ and optionally an additive component), which is sufficient for achieving urease inhibition as described below. More exemplary information about amounts, ways of application, and suitable ratios to be used is given below. A skilled artisan is well aware of the fact that such an amount can vary in a broad range, and is dependent on various factors, e.g., weather, target species, locus, mode of application, soil type, treated cultivated plant or material, and the climatic conditions.

As used herein, the term “green solvent” is to be understood as being an environmentally friendly solvent, or biosolvents, which is derived from the processing of agricultural crops. Examples of green solvents include ionic liquids, supercritical fluids, water and supercritical water. These solvents are eco-friendly, less toxic, less hazardous than traditional organic compounds.

As used herein, the term “safe solvent” is to be understood as being solvents that are considered to be environmentally safe and includes solvents such as water, ethanol, 1-propanol, acetone, acetonitrile, 2-propanol, and methanol.

As used herein, the term “synergistically effective” refers to an effect that is obtained from two different chemicals (e.g., tBHQ and an additive component) that is greater than the sum of their individual effects at the same doses.

The term “synergistic effect” means that the improvement in the development of the plant in relation to at least one effect is increased to an extent greater than that resulting from an additive effect. An additive effect is the expected effect due to each active compound acting individually. A synergistic effect occurs to a significantly greater degree than an additive effect. The expected activity for a given combination of two active compounds can be calculated as follows (cf. Colby, S. R., “Calculating Synergistic and Antagonistic Responses of Herbicide Combinations”, Weeds 15, pages 20-22, 1967). The synergistic effect of the active ingredient combination used in accordance with the embodiments allows the total application rate of the substances to achieve the same effect to be reduced.

As used herein, the term “micronutrient” is to be understood as nutrients essential to plant growth and health that are only needed in very small quantities. A non-limiting list of micronutrients required by plants includes zinc (Zn), iron (Fe), manganese (Mn), copper (Cu), boron (B), molybdenum (Mo), and chlorine (Cl).

As used herein, the term “Size Guide Number (SGN)” refers to the diameter, expressed as millimeters×100, of the fertilizer granules based on the median (or midpoint) within the batch. It means that half of the fertilizer granules are larger than the set SGN and half are smaller. This is determined by passing the fertilizer through various sieves and using the amounts retained by each to calculate the SGN. For example, a fertilizer of SGN 250 will have 50% of its particles retained on or around a sieve with a 2.5-millimeter opening.

As used herein, the term “median” refers to the value where half of the particle population resides above this point, and half of the particles resides below this point and is usually reported in millimeters (mm). For a particle size distribution, the median is called the D50 of a particle.

As used herein, the term “uniformity index (UI)” refers to as a variable that expresses relative particle size variation. UI values within the range of about 40-60 indicate that the particles are uniform in size. The larger the UI value, the more uniform in particle size variation of a product. Values outside this range indicate large variability in particle size distribution. UI is the ratio of a larger (d95) to smaller (d10) granule for a specific granular composition multiplied by 100: Formula to calculate UI is =D10/D95×100, wherein D10=particle diameter (mm) corresponding to 10% passing and D95=particle diameter (mm) corresponding to 95% passing. For example, the meaning of a product with a UI of 50=average small particle (0.80 mm) is half the size of the average large particle (1.6 mm). A product with varying particle sizes and density can result in inconsistent distribution of product delivering inconsistent results.

As used herein, the term “mesh size” refers to the U.S. Mesh Size (or U.S. Sieve Size) that is defined as the number of openings in one square inch of a screen. For example, a 36 mesh screen will have 36 openings while a 150 mesh screen will have 150 openings. Since the size of screen (one square inch) is constant, the higher the mesh number the smaller the screen opening and the smaller the particle that will pass through. Generally, U.S. Mesh Size is measured using screens down to a 325 mesh (325 openings in one square inch).

Sometimes the mesh size of a product is noted with either a minus (−) or plus (+) sign. These signs indicate that the particles are either all smaller than (−) or all larger than (+) the mesh size. For example, a product identified as −100 mesh would contain only particles that passed through a 100 mesh screen. A +100 grade would contain particles that did not pass through a 100 mesh screen. When a grade of product is noted with a dash or a slash, it indicates that the product has particles contained within the two mesh sizes. For example, a 30/70 or 30-70 grade would only have particles that are smaller than 30 mesh and larger than 70 mesh.

As used herein, the term “particle density” refers to the mass to volume ratio of particles and/or granules that is reported as lbs/ft³ or kg/m³. Unlike bulk density, particle density does not include the space between individual particles but rather a measurement of the particle density itself.

As used herein, the term “soil” is to be understood as a natural body comprised of living (e.g., microorganisms (such as bacteria and fungi), animals, and plants) and nonliving matter (e.g., minerals and organic matter (e.g., organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal, and seaweed extracts. Further examples are enzymatically digested proteins, fish meal, and feather meal. The decomposing crop residue from prior years is another source of fertility. In addition, naturally occurring minerals such as mine rock phosphate, sulfate of potash, and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, and rabbits, and guano from seabirds and bats. The application rates of animal manure when used as fertilizer highly depends on the origin (type of animals). Plant manures may derive from any kind of plant, whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer), or seaweed.

As used herein, the term “seed” comprises seeds of all types, such as, for example, corns, seeds, fruits, tubers, seedlings, and similar forms. The seed used can be the seed of the useful plants mentioned above, but also the seed of transgenic plants or plants obtained by customary breeding methods.

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the term “about,” when referring to a value is meant to encompass variations of, in some embodiments ±5%, in some embodiments ±2%, in some embodiments ±1%, in some embodiments ±0.5%, and in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller ranges is also encompassed, subject to any specifically excluded limit in the stated range. Where the stated range includes one or both of the limits, ranges excluding either or both of those included limits are also included.

Additional definitions may follow below.

### II. COMPOSITION

The presently disclosed subject matter relates to a urease inhibitor composition comprising tert-butylhydroquinone (tBHQ) and an organic solvent. As already mentioned above, these urease inhibitor compositions can exhibit desirable properties such as increased chemical/thermal stability, increased shelf life, reduced volatility, reduced application rate, ease of handling, extended/prolonged effect of urease inhibition, as well as excellent environmental and toxicology profiles, all of which generally contribute to an increased performance in the field.

In some embodiments, the urease inhibitor composition further comprises an additive component. The function of the additive component is to promote the beneficial properties tBHQ when formulated alone or in combination with an agricultural product (i.e., a fertilizer). In some embodiments, the additive component and the organic solvent can be the same. In some embodiments, the organic solvent and the additive component are different.

The amount of tert-butylhydroquinone present in the urease inhibitor composition can vary. For example, in some embodiments, the amount of tert-butylhydroquinone ranges from about 0.001% to about 70%, from about 0.01% to about 65%, from about 0.1% to about 65%, from about 1% to about 65%, from about 1% to about 60%, from about 1% to about 50%, from about 5% to about 45%, from about 10% to about 40% from about 15% to about 35% from about 20% to about 30% or from about 25% to about 30% by weight based on the total weight of the urease inhibitor composition. In some embodiments, the amount of tert-butylhydroquinone present in the urease inhibitor composition is less than about 70%, about 65%, about 50%, about 45%, about 40%, about 35%, about 30%, about 25%, about 20%, about 15%, about 10%, about 5% or less than about 1% by weight based on the total weight of the urease inhibitor composition.

The amount of the additive component in the urease inhibitor composition can vary. For example, in some embodiments, the amount of the additive component ranges from about 0.001% to about 60%, from about 0.01% to about 60%, from about 0.1% to about 60%, from about 1% to about 60%, from about 2% to about 55%, from about 5% to about 50%, from about 10% to about 45%, from about 15%, to about 40%, from about 20% to about 35%, from about 20% to about 30%, or from about 20% to about 25% by weight based on the total weight of the urease inhibitor composition. In some embodiments, the amount of additive component present in the urease inhibitor composition is less than about 60%, about 55%, about 50%, about 45%, about 40%, about 35%, about 30%, about 25%, about 20%, about 15%, about 10%, about 5%, or less than about 1% by weight based on the total weight of the urease inhibitor composition.

In some embodiments, the relative amount of tert-butylhydroquinone and additive component present in the urease inhibitor composition can vary. In some embodiments, the amount of tert-butylhydroquinone and additive component present in the urease inhibitor composition ranges from about 1:1000 to about 1000:1, from about 1:500 to about 500:1, from about 1:250 to about 250:1, from about 1:150 to about 150:1, from about 1:100 to about 100:1, from about 1:75 to about 75:1, from about 1:50 to about 50:1, from about 1:25 to about 25:1, from about 1:15 to about 15:1, from about 1:10 to about 10:1, from about 1:5 to about 5:1, or from about 1:2 to about 2:1 weight ratio of tert-butylhydroquinone to additive component. In some embodiments, the tert-butylhydroquinone and additive component are present in the urease inhibitor composition in synergistically effective amounts.

The tert-butylhydroquinone, additive component and organic solvent are discussed in more detail below.

### A. Tert-Butylhydroquinone

Tert-butylhydroquinone (tBHQ, tertiary butylhydroquinone) is a synthetic aromatic organic compound. It is a derivative of hydroquinone (which is a type of phenol), substituted with a tert-butyl group and has the following chemical structure:

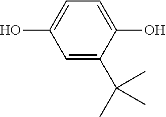

TBHQ is primarily used in foods as a preservative for unsaturated vegetable oils and many edible animal fats, where it acts as an antioxidant. In addition, tBHQ has been used in other applications such as: (a) in perfumery, where it is used as a fixative to lower the evaporation rate and improve stability; (b) in industry as a stabilizer to inhibit autopolymerization of organic peroxides; (c) in fuels as an antioxidant, e.g., in biodiesel; and (d) as an additive to varnishes, lacquers, resins, and oil-field additives.

However, its effects on urease inhibition, particularly urease inhibition in soil, has not been previously disclosed. It was therefore unexpected and surprising to find that tert-butylhydroquinone exhibits strong urease enzyme inhibitory properties when exposed to soil alone or in combination with fertilizer, particularly urea-containing fertilizer. Additional studies demonstrated that its strong urease enzyme inhibitory properties are due in great part because of the tert-butyl alkyl substituent present in the compound as unsubstituted hydroquinone exhibited significantly less efficacious urease enzyme inhibition properties.

### B. Additive Component

The additive component disclosed herein is a compound that when added to the urease inhibitor composition further promotes and/or enhances the urease enzyme inhibitory properties of tBHQ. In some embodiments, the additive component has a synergistic effect on the enzyme inhibitory properties of tBHQ.

In some embodiments, such an additive component is selected from compound classes such as an α,β-unsaturated carbonyl system-containing additive, an acid-containing additive, an ester-containing additive, an aromatic-containing additive, a glycol-containing additive, or a combination thereof. Not to be bound by theory, but it is believed that such compounds can participate in hydrogen bonding with tert-butylhydroquinone and can therefore be a suitable co-solvent in the disclosed urease inhibitory composition.

In some embodiments, the additive component comprises an α,β-unsaturated carbonyl system-containing additive. In some embodiments, the α,β-unsaturated carbonyl system-containing additive is derived from an acyclic monoterpene and/or contains one or more isoprene units. In some embodiments, the α,β-unsaturated carbonyl system-containing additive contains an aromatic ring system. Exemplary α,β-unsaturated carbonyl system-containing additives include, but are not limited to, citral (3,7-dimethyl-2,6-octadienal), mesityl oxide, α-amylcinnamaldehyde, coumarin (2H-chromen-2-one), or a combination thereof. In some embodiments, the additive component is mesityl oxide.

In some embodiments, the additive component comprises an aromatic ring system-containing additive, which can be any compound containing an aromatic ring system (e.g., a 6-membered aromatic ring such as aryl or a heteroaromatic moiety such as a heteroaryl). In some embodiments, such aromatic ring system is substituted with one or more hydrophilic groups (i.e., hydroxyl groups (—OH), alkoxides (—O(C₂-C₆ alkyl), esters (—C(═O)O(C₁-C₆ alkyl) and/or acyls (—C(═O)(C₁-C₆ alkyl)). Exemplary aromatic-containing additives include, but are not limited to, butylated hydroxyanisole, eugenol, salicylaldehyde, acetophenone, methyl salicylate, or a combination thereof.

In some embodiments, the additive component comprises an acid-containing additive, which can be any compound containing one or more carboxylic acid (—COOH) groups, sulfonic acid (—SO₃H) groups, and/or phosphoric acid (—PO₃H) groups. In some embodiment, the acid-containing additive contains a C₂-C₁₀ alkyl chain, which can be saturated or unsaturated. In some embodiments, the acid-containing additive is a carbocyclic acid. Exemplary acid-containing additive include, but are not limited to, itacoic acid, adipic acid, maleic acid, octanoic acid, ethyl maltol, ascorbic acid, levulinic acid, or a combination thereof.

In some embodiments, the additive component comprises an ester-containing additive. In some embodiments, the ester-containing additive is a substituted or unsubstituted C₂-C₁₂ alkyl ester. In some embodiments, such ester is substituted with hydrophilic groups such as hydroxyl (—OH). Exemplary ester-containing additives include, but are not limited to, triethyl citrate, isobornyl acetate, propylene carbonate, ethyl lactate, or a combination thereof.

In some embodiments, the additive component comprises a glycol-containing additive, which is an alkyl compound containing at least two hydroxyl (—OH) groups. Exemplary glycol-containing additives include, but are not limited to, diethylene glycol monoethyl ether, ethylene glycol, monobutyl ether, or a combination thereof.

In some embodiments, the additive component comprises stereoisomers. In some embodiments, the additive component comprises enantiomers. In such embodiments, the additive component can comprise an enantiomeric purity of at least about 50%, about 60%, about 70%, about 75%, about 80%, about 85%, about 90%, about 95%, about 98%, about 99%, about 99.5%, or at least about 99.8% enantiomeric excess (ee). In some embodiments, the additive component comprises diastereomers. In such embodiments, the additive component can comprise a diastereomeric purity of at least about 50%, about 60%, about 70%, about 75%, about 80%, about 85%, about 90%, about 95%, about 98%, about 99%, about 99.5%, or at least about 99.8% diastereomeric excess (de). In some embodiments, the additive component is racemic.

### C. Organic Solvent

In some embodiments, the organic solvent is one or more polar organic solvent(s). In some embodiments, the one or more polar organic(s) solvent are EPA approved. EPA-approved solvents are those that are found in the electronic code of federal regulations, for example in Title 40, Chapter I, Subchapter E, Part 180. EPA-approved solvents include, but are not limited to, the solvents listed in Table 1.

TABLE 1
EPA-approved solvents

| | |
|---|---|
| 1,3-Propanediol (CAS Reg. No. | Isopropyl-3-hydroxybutyrate (CAS Reg. |
| 504-63-2) | No. 54074-94-1) |
| 2-Ethylhexanol | Kerosene, U.S.P. reagent |
| 2-methyl-1,3-propanediol (CAS Reg. | Lactic acid |
| No. 2163-42-0) | |
| 2-Methyl-2,4-pentanediol | Lactic acid, 2-ethylhexyl ester (CAS |
| | Reg. No. 6283-86-9) |
| Acetic anhydride | Lactic acid, n-propyl ester, (S); (CAS |
| | Reg. No. 53651-69-7) |
| Acetone (CAS Reg. No. 67-64-1) | Mesityl oxide |
| Ammonium hydroxide | Methyl 5-(dimethylamino)-2-methyl-5- |
| | oxopentanoate (1174627-68-9) |
| Amyl acetate | Methyl alcohol |
| Benzyl acetate (CAS Reg. No. 140-11-4) | Methyl esters of fatty acids derived |
| | from edible fats and oils |
| C₁₀₋₁₁ rich aromatic hydrocarbons (CAS | Methyl isobutyl ketone |
| Reg. No. 64742-94-5) | |
| C₁₁₋₁₂ rich aromatic hydrocarbons (CAS | Methyl isobutyrate (CAS Reg. No. 547-63-7) |
| Reg. No. 64742-94-5) | |
| C₉ rich aromatic hydrocarbons (CAS Reg. | Methyl n-amyl ketone (CAS Reg. No. 110-43- |
| No. 64742-95-6) | 0) |
| Choline chloride (CAS Reg. No. 67-48-1) | Mineral oil |
| Cod liver oil | Morpholine 4-C₆₋₁₂ Acyl Derivatives (CAS |
| | Reg. No. 887947-29-7) |
| Cyclohexane | n-Butanol (CAS Reg. No. 71-36-3) |
| Cyclohexanone | n-Butyl benzoate (CAS Reg. No.136-60-7) |
| Decanamide, N,N-dimethyl (CAS Reg. | n-Butyl-3-hydroxybutyrate (CAS Reg. |
| No. 14433-76-2) | No. 53605-94-0) |
| Diethylene Glycol (CAS No. 111-46-6) | n-Decyl alcohol (CAS Reg. No. 112-30-1) |
| Diethylene glycol mono butyl ether (CAS | n-Hexyl alcohol (CAS Reg. No. 111-27-3) |
| Reg. No. 112-34-5) | |
| Diethylene Glycol MonoEthyl Ether (CAS | N-Methylpyrrolidone (CAS Reg. No. 872-504) |
| Reg. No. 111-90-0) | |
| Diethylphthalate | n-Octyl alcohol (CAS Reg. No. 111-87-5) |
| Diisopropyl adipate (CAS Reg. | n-Propanol |
| No. 6938-94-9) | |
| Dimethyl adipate (CAS Reg. No. 627-93-0) | Octanamide, N,N-dimethyl (CAS Reg. |
| | No. 1118-92-9) |
| Dimethyl glutarate (CAS Reg. No. 1119-40- | Oxo-decyl acetate (CAS reg. No. 108419-33-6) |
| 0) | |
| Dimethyl succinate (CAS Reg. No. 106-65- | Oxo-heptyl acetate (CAS Reg. No. 90438-79-2) |
| 0) | |
| Dimethyl sulfoxide (CAS Reg. No. 67-68-5) | Oxo-hexyl acetate (CAS Reg. No. 88230-35-7) |
| Di-n-butyl carbonate (CAS Reg. | Oxo-nonyl acetate (CAS Reg. No. 108419-34- |
| No. 542-52-9) | 7) |
| Dipropylene glycol | Oxo-octyl acetate (CAS Reg. No. 108419-32-5) |
| Distillates, (Fishcher-Tropsch), heavy, | Oxo-tridecyl acetate (CAS Reg. |
| C₁₈-C₅₀, branched, cyclic and linear | No. 108419-35-8) |
| (CAS Reg. No. 848301-69-9) | |
| d-Limonene (CAS Reg. No. 5989-27-5) | Petroleum hydrocarbons, light odorless |
| | conforming to 21 C.F.R. § 172.884 |
| Edible fats and oils | Phenol |
| Ethyl acetate | Propanoic acid, 2-methyl-, monoester with |
| | 2,2,4-trimethyl-1,3-pentanediol (CAS Reg. |
| | Reg. No. 25265-77-4) |
| Ethyl alcohol | Propylene glycol |
| Ethyl esters of fatty acids derived from | Propylene glycol monomethyl ether (CAS Reg. |
| edible fats and oils | No. 107-98-2) |
| Ethylene glycol (CAS Reg. No. 107-21-1) | Soybean oil-derived fatty acids |
| Glycerol mono-, di-, and triacetate | Tall oil fatty acid (CAS Reg. No. 61790-12-3) |
| Hydrochloric acid | Tetraethylene glycol (CAS Reg. No. 112-60-7) |
| Isobornyl acetate | Toluenesulfonic acid |
| Isobutyl acetate (CAS Reg. No. 110-19-0) | Triacetin (glyceryl triacetate) |
| Isobutyl isobutyrate (CAS Reg. | Xylene |
| No. 97-85-8) | |
| Isobutyric acid (CAS Reg. No. 79-31-2) | γ-Butyrolactone |
| Isopropyl myristate (CAS Reg. | |
| No. 110-27-0) | |

In some embodiments, the organic solvent is selected from a sulfone, a sulfoxide, an aromatic solvent, a halogenated solvent, a glycol-based solvent, a fatty acid-based solvent, an acetate-containing solvent, a ketone-containing solvent, an ether polyol-containing solvent, an amide-containing solvent, and combinations thereof. In some embodiments, the organic solvent is environmentally friendly, such as a green solvent, a safe solvent, or a combination thereof.

In some embodiments, the one or more organic solvent(s) are all relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent. In some embodiments, the organic solvent is a liquid at 20° C.

In some embodiments, the organic solvent is a sulfone. A sulfone is a solvent that contains a sulfonyl functional group attached to two carbon atoms and is represented by the general structure R′—S(═O)₂—R″, wherein both R groups contain carbon atoms. A sulfone solvent can be, but is not limited to, sulfolane, methyl sulfolane (3-methyl sulfolane), dimethylsulfone, or a combination thereof. In some embodiments, the organic solvent is a sulfoxide. A sulfoxide solvent contains a sulfinyl (SO) functional group attached to two carbon atoms and is generally represented by R′—S(═O)—R″, wherein both R groups contain carbon atoms. A sulfoxide solvent can be, but is not limited to, dimethyl sulfoxide.

In some embodiments, the organic solvent is an ether polyol. An ether polyol contains multiple hydroxyl groups. An ether-polyol solvent can be, but is not limited to, polyethylene glycols, polypropylene glycols, polyalkylene glycols, and related compounds. In some embodiments, the polyethylene glycol has two terminal alcohols (e.g., polyethylene glycol 3350). Exemplary polyethylene glycols include, but are not limited to, diethylene glycol, triethylene glycol, or a combination thereof. Exemplary polypropylene glycols include, but are not limited to, dipropylene glycol, tripropylene glycol, or a combination thereof. In some embodiments, a polypropylene glycol has three terminal alcohols. Exemplary polypropylene glycols having three terminal alcohols, known as propoxylated glycerol, include, but are not limited to, Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, ether polyol comprises a polyethylene or a polypropylene glycol in the molecular weight range of between about 200 and about 10,000 Da. In some embodiments, one or more of the hydroxyl groups present in the ether polyol is modified. For example, in some embodiments, one or more of the hydroxyl groups present in the ether polyol are alkylated and/or esterified. Exemplary modified ether polyols include, but are not limited to, triacetin, n-butyl ether of diethylene glycol, ethyl ether of diethylene glycol, methyl ether of diethylene glycol, acetate of the ethyl ether of dipropylene glycol, or a combination thereof.

In some embodiments, the organic solvent is a glycol-based solvent. A glycol is an alcohol that contains two hydroxyl (—OH) groups that are attached to different carbon atoms (e.g., terminal carbon atoms). Exemplary glycol-based solvents include, but should not be limited to, ethylene glycol and/or propane-1,2,3-triol.

In some embodiments, the organic solvent is a fatty acid-based solvent. In general, a fatty acid is characterized as a compound with a carboylic acid and an aliphatic chain containing multiple carbon atoms, which can be saturated or unsaturated. In some embodiments, the fatty acid contains between 3 to about 20 carbon atoms. Example of fatty acid-based solvents include, but are not limited to, a dialkyl amide of a fatty acid (e.g., a dimethylamide). Examples of a dimethylamide of a fatty acid include, but are not limited to, a dimethyl amide of a caprylic acid, a dimethyl amide of a C₈-C₁₀ fatty acid (Agnique AMD810), a dimethyl lactamide (Agnique AMD3L), or a combination thereof.

In some embodiments, the organic solvent is a ketone-containing solvent, which can be any solvent containing a carbonyl functional group (C═O). Examples of ketone-containing solvent include, but are not limited to, isophorone, trimethylcyclohexanone, or a combination thereof.

In some embodiments, the organic solvent is an acetate-containing solvent. Examples of acetate-containing solvents include, but are not limited to, acetate, hexyl acetate, heptyl acetate, or a combination thereof.

In some embodiments, the organic solvent is an amide-containing solvent, which can be any solvent containing and amide functionality (—NR′C(═O)R″; wherein R is an alkyl group). Examples of amide-containing solvents include, but are not limited to, Rhodiasolv ADMA10 (CAS Reg. No. 14433-76-2; N,N-dimethyloctanamide), Rhodiasolv ADMA810 (CAS Reg. No. 1118-92-9/14433-76-2; blend of N,N-Dimethyloctanamide and N,N-diemthyldecanamide), Rhodiasolv PolarClean (CAS Reg. No. 1174627-68-9; methyl 5-(dimethylamino)-2-methyl-5-oxopentanoate), or a combination thereof.

In some embodiments, the organic solvent is a halogenated solvent, which can be any solvent containing one or more halogens (i.e., chlorine, bromine, iodine, and fluorine). In some embodiments, the halogenated solvent is a halogenated aromatic hydrocarbon. An example of a halogenated aromatic hydrocarbon is chlorobenzene. In some embodiments, the halogenated solvent is a halogenated aliphatic hydrocarbon. An example of a halogenated aliphatic hydrocarbon is 1,1,1-trichloroethane.

In some embodiments, the organic solvent is an aromatic solvent. In some embodiments, the aromatic solvent is an aromatic hydrocarbon. Exemplary aromatic hydrocarbons include, but are not limited to, benzene, napthylene, or a combination thereof. In some embodiments, the aromatic hydrocarbon is substituted. Examples of substituted aromatic hydrocarbons include, but are not limited to, alkyl substituted benzenes and/or alkyl substituted naphtalenes. Examples of alkyl substituted benzenes include xylene(s), toluene, propylbenzene, or a combination thereof. In some embodiments, the organic solvent comprises xylene(s). In some embodiments, the aromatic hydrocarbon is a mixture of substituted and unsubstituted aromatic hydrocarbons, such as, but not limited to a mixture of naphthenic and alkyl substituted naphtlene.

In some embodiments, the aromatic solvent is a mixture of hydrocarbons. For example, in some embodiments, the aromatic solvent is aromatic 100, a solvent containing Naphtha (CAS Reg. No. 64742-95-6), which is a combination of hydrocarbons obtained from distillation of aromatic streams consisting predominantly of aromatic hydrocarbons C₈ through C₁₀), or aromatic 200, a solvent containing a mixture of: aromatic hydrocarbon (C₁₁-C₁₄) present in 50-85% by weight; naphthalene (CAS Reg. No. 91-20-3) present in 5-20% by weight; aromatic hydrocarbon (C₁₀) not including naphthalene present in 5-15% by weight; and aromatic hydrocarbon (C₁₅-C₁₆) present in 5-15% by weight based on the total weight of the aromatic 200 composition. In some embodiments, the aromatic hydrocarbon is a mixture of aromatic 100 and aromatic 200.

In some embodiments, the organic solvent is a green solvent. Exemplary green solvents in addition to the solvent already mentioned above include, but are not limited to, water, methanol, acetone, dimethyl carbonate, ethyl acetate, propyl acetate, 1-propanol, 1-butanol, toluene, dimethyl sulfoxide (DMSO), acetic acid, acetonitrile, tetrahydrofuran (THF), ethylene glycol, 2-methyl tetrahydrofuran, methyl-t-butyl ether, methylcyclohexane, xylene(s), cyclohexane, isooctane, heptane, methyl ethyl ketone, ethylene glycol, methyl t-butyl ether, toluene, cyclohexane, methylcyclohexane, or combinations thereof. In some embodiments, the green solvent comprises DMSO. In some embodiments, the green solvent comprises xylene(s).

In some embodiments, the organic solvent is a safe solvent. Exemplary safe solvents in addition to the solvent already mentioned above include, but are not limited to, simple alcohols (e.g., methanol, ethanol, isopropanol, etc.) and/or alkanes (e.g., heptane, hexane, etc.).

In some embodiments, the organic solvent is the same as the additive component described above, meaning the organic solvent is selected from the additive components described above.

In some embodiments, the composition containing tert-butylhydroquinone (and optionally the additive component) can be formulated with two or more different solvent types. The tert-butylhydroquinone (and optionally the additive component) can be formulated in two different solvent types that can exhibit high solvation, lack of volatility, and suitable environmental and toxicological profiles. The two different solvent types can be selected from two different aromatic solvents, two different sulfones, two different amide-containing solvents, two different ether polyols, two different sulfoxides, two different amide-containing solvents, two different fatty acid-based solvents, two different green solvents, two different safe solvents, or a sulfoxide and an aromatic solvent. In some embodiments, the two different solvent types are xylene(s) and dimethylsulfoxide. The amount of each solvent type present in the composition can vary. In some embodiments, the first solvent (e.g., xylene(s)) of the two or more different solvent types is present in an amount ranging from about 10% to about 90%, from about 20% to about 80%, from about 25% to about 70%, from about 30% to about 60%, from about 35% to about 55%, or from about 40% to about 50% w/w based on the total weight of the composition. In some embodiments, the first solvent of the two or more different solvent types is present in an amount of less than about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, about 5%, or less than 1% w/w based on the total weight of the composition. In some embodiments, the second solvent (e.g., dimethylsulfoxide (DMSO)) of the two or more different solvent types is present in an amount ranging from about 10% to about 90%, from about 20% to about 80%, from about 25% to about 70%, from about 30% to about 60%, from about 35% to about 55%, from about 40% to about 50% w/w based on the total weight of the composition. In some embodiments, the second solvent of the two or more different solvent types is present in an amount of less than about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, about 5%, or less than 1% w/w based on the total weight of the composition.

In some embodiments, the relative amount of the two different solvent types can vary. For example, in some embodiments, the first solvent and the second solvent are present in the urease inhibitor composition in amounts ranging from about 100:1 to about 1:100, from about 75:1 to about 1:75, from about 50:1 to about 1:50, from about 25:1 to about 1:25, from about 10:1 to about 1:10, from about 5:1 to about 1:5, from about 3:1 to about 1:3, from about 2:1 to about 1:2, or about 1:1 weight ratio of first solvent:second solvent. In some embodiments, the first solvent is dimethyl sulfoxide and the second solvent is xylenes and they are present in the urease inhibitor composition in amounts ranging from about 1:2 to about 2:1 or are about 1:1 weight ratio.

The organic solvent can be present in the composition at an amount from 0.1% w/w to about 99.9% w/w based on the total weight of the urease inhibitor composition. In some embodiments, the amount of organic solvent is less than about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, or less than about 5% w/w based on the total weight of the composition. In embodiments, the amount of organic solvent is from about 5% to about 98%, from about 10% to about 90%, from about 20% to about 80%, from about 25% to about 75%, from about 30% to about 70%, from about 35% to about 65%, from about 40% to about 60%, or from about 45% to about 55% w/w based on the total weight of the composition.

In some embodiments, the urease inhibitor composition disclosed herein can be formulated to include one or more co-formulants. Exemplary co-formulants include, but are not limited to, any co-formulant known in the art such as solvents, surface active ingredients (i.e., surface active agent), dispersants, carriers, stability agents, wetting agents, emulsifiers, anti-foaming agents, preservatives, dyes, etc.

In some embodiments, the urease inhibitor compositions disclosed herein is formulated to not contain any co-formulants. In some embodiments, the urease inhibitor composition disclosed herein consists of tBHQ and an organic solvent. In some embodiments, the urease inhibitor composition consists of tBHQ, an organic solvent and an additive component.

### III. AGRICULTURAL COMPOSITIONS

Any of the described urease inhibitor compositions can be combined with one or more other ingredients, selected from the group consisting of fertilizer, agriculturally active compounds, seed, compounds having urease inhibition activity, nitrification inhibition activity, pesticides, herbicides, insecticides, fungicides, miticides, and the like.

In some embodiments, the described urease inhibitor composition may be mixed with a fertilizer product in liquid form or may be applied as a surface coating to fertilizer products in solid form.

In some embodiments, the described urease inhibitor composition is thoroughly mixed with fertilizer products in liquid form. In such combined fertilizer/urease inhibitor composition-containing products, the tert-butylhydroquinone (or urease inhibitor composition) can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/urease inhibitor composition-containing products, the combined product can be applied at a level so that the amount of tert-butylhyroquinone (or urease inhibitor composition) applied is about 10-150 g per acre of soil, about 30-125 g per acre of soil, or about 40-120 g per acre of soil.

In some embodiments, the described urease inhibitor composition is applied as liquid or as a dispersion onto the surface of a fertilizer in solid form. When the urease inhibitor composition is used as a coating, the urease inhibitor composition can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

In some embodiments, the fertilizer coated with the described urease inhibitor composition is a solid urea-containing fertilizer. In some embodiments, the solid urea-containing fertilizer is in the form of granules or prills. In some embodiments, the shape of the granules or prills are round (e.g., spherical or egg-shaped) but should not be limited thereto. Additional shapes include cubic, rectangular and/or irregular.

In some embodiments, the granular/prill urea-containing fertilizer contains granules/prills having an average mesh size ranging from about 1 to about 100 (e.g., 1/100), from about 10 to about 100 (e.g., 10/100), or from about 16 to about 100 (e.g., 16/100) U.S. mesh. In other embodiments, the granular/prill urea-containing fertilizer contains granules/prills having an average mesh size ranging from about 4 to about 30 (e.g., 4/30), from about 5 to about 24 (e.g., 5/24), or from about 6 to about 16 (e.g., 6/16) U.S. mesh.

In some embodiments, the median particle size (d50) of the granules/prills of urea-containing fertilizer ranges from about 0.1 to 3.5 mm, from about 0.5 to about 2.5 mm, from or from about 0.9 to about 1 mm (or about 0.5, 0.6, 0.7, 0.8, 0.9, 1.0, 1.5, 2.0, 2.1, 2.2, 2.3, 2.4, or 2.5 mm). In some embodiments, the median particle size (d50) of the granules/prills of the urea-containing fertilizer is less than about 3.5 mm, 3.0 mm, 2.5 mm, 2.0 mm, 1.5 mm or 1.0 mm.

In some embodiments, the granular/prill urea-containing fertilizer contains granules/prills having a particle size ranging from about 10 to about 500, from about 50 to about 450, from about 75 to about 400, from about 80 to about 250, or from about 90 to about 230 Size Guide Number (SGN).

In some embodiments, the granular/prill urea-containing fertilizer contains granules/prills having a uniformity index (UI) ranging between about 30-40, 30-50, 35-45, 40-60, 40-50, or 50-60 (indicating that the granules are uniform in size).

In some embodiments, the granular/prill urea-containing fertilizer contains granules/prills having a particle density ranging from about 10-150 lbs/ft³, 30-100 lbs/ft³, from about 45-85 lbs/ft³, or from about 45-60 lbs/ft³.

In some embodiments, the granular/prill urea-containing fertilizer has a bulk density of from about 10-150 lbs/ft³, 30-100 lbs/ft³, from about 45-75 lbs/ft³, from about 50-70 lbs/ft³ or from about 60-70 lbs/ft³. In some embodiments, the bulk density is a “loose” bulk density.

Granulation of the (urea-containing) fertilizer can be carried out using any known granulation method in the art. In some embodiments, granulation of the urea-containing fertilizer can be achieved using dry granulation methods such as compaction granulation methods. During this physical process, finely divided urea-containing particles are formed into granules without compromising the chemical stability and/or structural integrity of the urea source used. This enables the product to be handled, blended and spread in the farmer's field in a uniform manner, while maintaining its unique chemical attributes. In some embodiments, granulation of the urea-containing fertilizer can be achieved via pan granulation, drum granulation, extrusion, palletization, granular crumble but should not be limited thereto.

### A. Fertilizers

In some embodiments, the agricultural product is a fertilizer. The fertilizer can be a solid fertilizer, such as, but not limited to, a granular fertilizer, and the urease inhibitor composition can be applied to the fertilizer as a liquid dispersion. However, the fertilizer can also be in liquid form, and the urease inhibitor composition in liquid form can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer is or contains urea and/or ammonia, including anhydrous ammonia fertilizer. In some embodiments, the fertilizer comprises plant-available nitrogen, phosphorous, potassium, sulfur, calcium, magnesium. or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of. Fe, Mn, Mg, Zn, Cu, Ni, Co, Mo, V, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material). For example, in some embodiments, the fertilizer is a the urea-containing fertilizer in solid form. In another embodiment, the fertilizer is a urea-containing fertilizer in liquid form.

In some embodiments, the urease inhibitor composition is combined with any suitable liquid fertilizer or used as a coating for any suitable solid fertilizer for application to fields and/or crops.

The described urease inhibitor composition can be applied with the application of a fertilizer. The urease inhibitor composition can be applied prior to, subsequent to, or simultaneously with the application of fertilizers.

Urease inhibitor composition-containing fertilizer products can be applied in any manner which will benefit the crop of interest. In some embodiments, the products are applied to growth mediums in a band or row application. In some embodiment, the products are applied to or throughout the growth medium prior to seeding or transplanting the desired crop plant. In some embodiment, the products are applied to the root zone of growing plants.

The plants and/or crops include plants such as cereals, fruit trees, fruit bushes, grains, legumes and combinations thereof. Exemplary crops include, but are not limited to, rye, oats, maize, rice, sorghum, triticale, oilseed rape, rice, soybeans, sugar beet, sugar cane, turf, fruit trees, palm trees, coconut trees or other nuts, grapes, fruit bushes, fruit plants; beet, fodder beet, pomes, stone fruit, apples, pears, plums, peaches, almonds, cherries, and berries, for example strawberries, raspberries and blackberries; leguminous plants such as beans, lentils, peas, soybeans, peanuts; oil plants, for example rape, mustard, sunflowers; cucurbitaceae, for example marrows, cucumbers, melons; fibre plants, for example cotton, flax, hemp, jute; citrus fruit, for example oranges, lemons, grapefruit and mandarins; vegetables, for example spinach, lettuce, asparagus, cabbages, carrots, onions, tomatoes, potatoes, sweet potatoes, yams, paprika; as well as ornamentals, such as flowers, shrubs, broad leaved trees and evergreens, for example conifers, cereals, wheat, barley, oats, winter wheat, spring wheat, winter barley, spring barley, triticale, cereal rye, winter durum wheat, spring durum wheat, winter oat, spring oat, fodder cereals, ray-grass, cocksfoot, fescue, timothy, grass for seed and grassland and any combination thereof.

### B. Seed

Some embodiments describe agricultural seeds coated with the urease inhibitor compositions as disclosed herein. The urease inhibitor composition can be present in the seed product at a level of from about 0.001% to about 10%, about 0.004% to about 2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soya bean, cotton, or oilseed rape.

### C. Other

In some embodiments, urease inhibiting compounds, nitrification inhibiting compounds, pesticides, herbicides, insecticides, fungicides, and/or miticides are combined with the urease inhibitor composition disclosed herein. As used herein, “pesticide” refers to any agent with pesticidal activity (e.g., herbicides, insecticides, and fungicides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, OH), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester, and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap-4, dinocap-6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, XMC, xylylcarb, zeta cypermethrin and zolaprofos.

Exemplary fungicides include, but are not be limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, Fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the composition of the presently disclosed subject matter is a pesticide/urease inhibitor composition-containing product comprising a pesticide and tert-butylhydroquinone (and optionally an additive component). In some embodiments, the pesticide is an herbicide, insecticide, or a combination thereof.

The amount of urease inhibitor composition in the pesticide/urease inhibitor composition-containing product can vary. In some embodiments, the amount of urease inhibitor composition is present at a level of from about 0.05% to about 10% by weight (more preferably from about 0.1% to about 4% by weight, and most preferably from about 0.2% to about 2% by weight) based upon the total weight of the pesticide/urease inhibitor composition-containing product taken as 100% by weight.

Exemplary classes of miticides include, but are not be limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

### IV. METHODS

In some embodiments, the urease inhibitor composition is used directly. In other embodiments, the urease inhibitor composition is formulated in ways to make its use convenient in the context of productive agriculture. The urease inhibitor composition used in these methods includes tert-butylhydroquinone, an organic solvent, and optionally an additive component as described above. The urease inhibitor composition can be used in methods such as:
A. Methods of Improving Plant Growth and/or Plant Health and/or Fertilizing Soil
B. Methods of Inhibiting Urease Enzyme Activity
C. Methods for Inhibiting Ammonia Release or Evolution
D. Methods of Improving Soil Conditions
E. Methods of Preparing a Urease Inhibitor Composition
A. Methods for improving plant growth comprise contacting a urease inhibitor composition containing tert-butylhydroquinone, an organic solvent, and optionally an additive component as disclosed herein with soil. In some embodiments, the urease inhibitor composition is applied to the soil prior to emergence of a planted crop. In some embodiments, the urease inhibitor composition is applied to the soil adjacent to the plant and/or at the base of the plant and/or in the root zone of the plant.

Methods for improving plant growth can also be achieved by applying a urease inhibitor composition containing tert-butylhydroquinone (and optionally an additive component) as a seed coating to a seed in the form of a liquid dispersion, which upon drying forms a dry residue. In these embodiments, seed coating provides the tert-butylhydroquinone (and optionally an additive component) in close proximity to the seed when planted so that the tert-butylhydroquinone can exert its beneficial effects in the environment where it is most needed. That is, the tert-butylhydroquione (and optionally an additive component) provides an environment conducive to enhanced plant growth in the area where the effects can be localized around the desired plant. In the case of seeds, the coating containing the tert-butylhydroquinone (and optionally an additive component) provides an enhanced opportunity for seed germination, subsequent plant growth, and an increase in plant nutrient availability.
B. Methods for inhibiting/reducing urease enzyme activity, the method comprising applying a urease inhibitor composition containing tert-butylhydroquinone (and optionally an additive component) to the soil. In some embodiments, the urease inhibitor composition is applied to the soil prior to emergence of a planted crop. In some embodiments, the urease inhibitor composition is applied to the soil adjacent to the plant and/or at the base of the plant and/or in the root zone of the plant.
C. Methods for inhibiting/reducing ammonia release or evolution in an affected area comprises applying a urease inhibitor composition containing tert-butylhydroquinone (and optionally an additive component) to the affected area. The affected area may be soil adjacent to a plant, a field, a pasture, a livestock or poultry confinement facility, pet litter, a manure collection zone, upright walls forming an enclosure, or a roof substantially covering the area, and in such cases the urease inhibitor may be applied directly to the manure in the collection zone. The urease inhibitor component is preferably applied at a level from about 0.005 to about 3 gallons per ton of manure, in the form of an aqueous dispersion having a pH from about 1 to about 5.
D. Methods for improving soil conditions selected from the group consisting of nitrification processes, urease activities, and combinations thereof, comprising the step of applying to soil an effective amount of a described urease inhibitor composition containing tBHQ. In some embodiments, the urease inhibitor composition is mixed with a urea-containing solid, liquid, or gaseous fertilizer, and especially solid fertilizers; in the latter case, the urease inhibitor composition is applied to the surface of the (urea-containing) fertilizer as an aqueous dispersion followed by drying, so that the urease inhibitor composition is present on the solid fertilizer as a dried residue. The urease inhibitor composition is generally applied at a level of from about 0.01% to about 10% by weight, based upon the total weight of the urease inhibitor composition/fertilizer product taken as 100% by weight. Where the fertilizer is an aqueous liquid fertilizer, the urease inhibitor composition is added thereto with mixing.
E. Methods of preparing a urease inhibitor composition, comprises contacting tert-butylhydroquinone with one or more organic solvents to form a mixture. In some embodiments, an additive component is added to the formed mixture.

In some embodiments, the methods A, B, and C above comprise contacting a desired area with a urease inhibitor composition at a rate of about 100 g to about 120 g per acre of the urease inhibitor composition. The urease inhibitor composition can, in some embodiments, be in solution at an amount of about 0.5 lbs to about 4 lbs per U.S. gallon, or from about 1 lb to about 3 lbs/per U.S. gallon, or about 2 lbs per U.S. gallon. In some embodiments, the method includes contacting the desired area at a rate of about 0.5 to about 4 qt/A, or about 1 to about 2 qt/A.

Particular embodiments of the subject matter described herein include:
1. A method of inhibiting urease enzyme activity, the method comprising applying a urease inhibitor composition to the soil, wherein the urease inhibitor composition comprises:
   tert-butylhydroquinone; and
   an organic solvent.
2. The method of embodiment 1, wherein the amount of tert-butylhydroquinone in the composition is from about 0.1% to about 65% based on the total weight of the composition.
3. The method of embodiment 1 or 2, wherein the organic solvent is selected from a sulfoxide, an aromatic solvent, a green solvent, a safe solvent, and a combination thereof.
4. The method of any above embodiment, wherein the organic solvent comprises dimethyl sulfoxide.
5. The composition of any above embodiment, wherein the organic solvent comprises dimethyl sulfoxide and xylene.
6. The method of embodiment 5, wherein dimethyl sulfoxide and xylene are present at a weight ratio of from about 1:2 to about 2:1.
7. The method of any above embodiment, wherein the urease inhibitor composition further comprises an additive component.
8. The method of embodiment 7, wherein the additive component is selected from an α,β-unsaturated carbonyl system-containing additive, an acid-containing additive, an ester-containing additive, an aromatic additive, a glycol-containing additive, and a combination thereof.
9. The method of embodiment 8, wherein the additive component is an α,β-unsaturated carbonyl system-containing additive selected from citral, mesityl oxide, α-amylcinnamaldehyde, coumarin, and a combination thereof.
10. The method of embodiment 8, wherein the additive component is an aromatic additive selected from butylated hydroxyanisole, eugenol, salicylaldehyde, acetophenone, methyl salicylate, and a combination thereof.
11. The method of embodiment 8, wherein the additive component is an acid-containing additive selected from itacoic acid, adipic acid, maleic acid, octanoic acid, ethyl maltol, ascorbic acid, levulinic acid, and a combination thereof.
12. The method of embodiment 8, wherein the additive component is an ester-containing additive selected from triethyl citrate, isobornyl acetate, propylene carbonate, ethyl lactate, and a combination thereof.
13. The method of embodiment 8, wherein the additive component is a glycol-containing additive selected from diethylene glycol monoethyl ether, ethylene glycol, monobutyl ether, and a combination thereof.
14. The method of any above embodiment 7-13, wherein tert-butylhydroquinone and the additive component are present in a weight ratio of from about 1:10 to about 10:1.
15. The method of any one of embodiments 7-14, wherein the additive component is present in an amount of from about 1% to about 50% by weight based on the total weight of the composition.
16. The method of any above embodiment, wherein the urease inhibitor composition further comprises a surfactant, a dispersant, an emulsifier, an anti-foam agent, a stability agent, or a combination thereof.
17. The method of any above embodiment, wherein at least about 50% of urease enzyme activity is being inhibited.
18. A method of fertilizing soil and/or improving plant growth and/or health comprising contacting a urease inhibitor composition with the soil, wherein the urease inhibitor composition comprises:
   tert-butylhydroquinone; and
   an organic solvent.
19. The method of embodiment 18, wherein the amount of tert-butylhydroquinone in the composition is from about 0.1% to about 65% by weight based on the total weight of the composition.
20. The method of embodiment 18, wherein the organic solvent is selected from a sulfoxide, an aromatic solvent, a green solvent, a safe solvent, and a combination thereof.
21. The method of embodiment 18, wherein the organic solvent comprises dimethyl sulfoxide.
22. The method of embodiment 18, wherein the organic solvent comprises dimethyl sulfoxide and xylene.
23. The method of embodiment 22, wherein dimethyl sulfoxide and xylene are present at a weight ratio of from about 1:2 to about 2:1.
24. The method of any one of embodiments 18-23, wherein the urease inhibitor composition further comprises an additive component.
25. The method of embodiment 24, wherein the additive component is selected from an α,β-unsaturated carbonyl system-containing additive, an acid-containing additive, an ester-containing additive, an aromatic additive, a glycol-containing additive.
26. The method of embodiment 25, wherein the additive component is an α,β-unsaturated carbonyl system-containing additive selected from citral, mesityl oxide, α-amylcinnamaldehyde, coumarin, and a combination thereof.
27. The method of embodiment 25, wherein the additive component is an aromatic additive selected from butylated hydroxyanisole, eugenol, salicylaldehyde, acetophenone, methyl salicylate, and a combination thereof.
28. The method of embodiment 25, wherein the additive component is an acid-containing additive selected from itacoic acid, adipic acid, maleic acid, octanoic acid, ethyl maltol, ascorbic acid, levulinic acid, and a combination thereof.
29. The method of embodiment 25, wherein the additive component is an ester-containing additive selected from triethyl citrate, isobornyl acetate, propylene carbonate, ethyl lactate, and a combination thereof.
30. The method of embodiment 25, wherein the additive component is a glycol-containing additive selected from diethylene glycol monoethyl ether, ethylene glycol, monobutyl ether, and a combination thereof.
31. The method of any one of embodiments 24-30, wherein tert-butylhydroquinone and the additive component are present in a weight ratio of from about 1:10 to about 10:1.
32. The method of any one of embodiments 24-31, wherein the additive component is present in an amount of from about 1% to about 50% by weight based on the total weight of the composition.
33. The method any one of embodiments 24-32, wherein the urease inhibitor composition further comprises a surfactant, a dispersant, an emulsifier, an antifoam agent, a stability agent, or a combination thereof.
34. An agricultural composition comprising:
   a urease inhibitor composition; and
   a solid urea-containing fertilizer,
wherein the urease inhibitor composition comprises
   tert-butylhydroquinone; and
   an organic solvent, and
wherein the surface of the urea-containing fertilizer is coated with the urease inhibitor composition.
35. The agricultural composition of embodiment 34, wherein the solid urea-containing fertilizer is in the form of granules or prills.
36. The agricultural composition of embodiment 35, wherein the solid urea-containing fertilizer granules have a mean particle size (d50) ranging from about 0.5 to about 2.5 mm.
37. The agricultural composition of embodiment 35, wherein the urea-containing fertilizer granules have a mesh size ranging from about 16 mesh to about 100 US mesh.
38. The agricultural composition of embodiment 34, wherein the urease inhibitor composition is present in an amount of from about 0.001% to about 10% by weight based on the total weight of the agricultural composition.
39. The agricultural composition of embodiment 34, wherein the amount of tert-butylhydroquinone in the composition is from about 0.1% to about 99.9%, 40. The agricultural composition of embodiment 34, wherein the organic solvent is selected from a sulfone, an aromatic solvent, a green solvent, a safe solvent, and a combination thereof.
41. The agricultural composition of embodiment 34, wherein the organic solvent comprises dimethyl sulfoxide.
42. The agricultural composition of embodiment 34, wherein the organic solvent comprises dimethyl sulfoxide and xylene.
43. The agricultural composition of embodiment 42, wherein dimethyl sulfoxide and xylene are present at a weight ratio of from about 1:2 to about 2:1.
44. The agricultural composition of any one of embodiment 34-43, wherein the urease inhibitor composition further comprises an additive component.
45. The agricultural composition of embodiment 44, wherein the additive component is selected from an α,β-unsaturated carbonyl system-containing additive, an acid-containing additive, an ester-containing additive, an aromatic additive, a glycol-containing additive.
46. The agricultural composition of embodiment 44, wherein the additive component is an α,β-unsaturated carbonyl system-containing additive selected from citral, mesityl oxide, α-amylcinnamaldehyde, coumarin, and a combination thereof.
47. The agricultural composition of embodiment 44, wherein the additive component is an aromatic additive selected from butylated hydroxyanisole, eugenol, salicylaldehyde, acetophenone, methyl salicylate, and a combination thereof.
48. The agricultural composition of embodiment 44, wherein the additive component is an acid-containing additive selected from itacoic acid, adipic acid, maleic acid, octanoic acid, ethyl maltol, ascorbic acid, levulinic acid, and a combination thereof.
49. The agricultural composition of embodiment 44, wherein the additive component is an ester-containing additive selected from triethyl citrate, isobornyl acetate, propylene carbonate, ethyl lactate, and a combination thereof.
50. The agricultural composition of embodiment 44, wherein the additive component is a glycol-containing additive selected from diethylene glycol monoethyl ether, ethylene glycol, monobutyl ether, and a combination thereof.
51. The agricultural composition of any one of embodiment 44-50, wherein tert-butylhydroquinone and the additive component are present in a weight ratio of from about 1:10 to about 10:1.
52. The agricultural composition of any one of embodiment 44-51, wherein the additive component is present in an amount of from about 1% to about 50% by weight based on the total weight of the composition.
53. The agricultural composition of any one of embodiment 44-52, wherein the urease inhibitor composition further comprises a surfactant, a dispersant, an emulsifier, an antifoam agent, a stability agent, or a combination thereof.
54. A method for preparing an agricultural composition of embodiment 34, the method comprising applying to the surface of the solid urea-containing fertilizer a urease inhibitor composition in the form of a liquid or dispersion, thereby coating the solid urea-containing fertilizer, wherein the urease inhibitor composition comprises:
   tert-butylhydroquinone; and
   an organic solvent.
55. The method of embodiment 54, wherein the solid urea-containing fertilizer is in the form of granules or prills.
56. The method of embodiment 55, wherein the solid urea-containing fertilizer granules have a mean particle size (d50) ranging from about 0.5 to about 2.5 mm.
57. The method of embodiment 55, wherein the urea-containing fertilizer granules have a mesh size ranging from about 16 mesh to about 100 US mesh.
58. The method of embodiment 54, wherein the urease inhibitor composition is applied in an amount of from about 0.001% to about 10% by weight based on the total weight of the agricultural composition.
59. The method of embodiment 54, wherein the amount of tert-butylhydroquinone in the composition is from about 0.1% to about 99.9% by weight based on the total weight of the composition.
60. The method of embodiment 54, wherein the organic solvent is selected from a sulfoxide, an aromatic solvent, a green solvent, a safe solvent, and a combination thereof.
61. The method of embodiment 60, wherein the organic solvent comprises dimethyl sulfoxide.
62. The method of embodiment 61, wherein the organic solvent comprises dimethyl sulfoxide and xylene.
63. The method of embodiment 62, wherein dimethyl sulfoxide and xylene are present at a weight ratio of from about 1:2 to about 2:1.
64. The method of any one embodiments of 54-63, wherein the urease inhibitor composition further comprises an additive component.
65. The method of embodiment 64, wherein the additive component is selected from an α,β-unsaturated carbonyl system-containing additive, an acid-containing additive, an ester-containing additive, an aromatic additive, a glycol-containing additive.
66. The method of embodiment 65, wherein the additive component is an α,β-unsaturated carbonyl system-containing additive selected from citral, mesityl oxide, α-amylcinnamaldehyde, coumarin, and a combination thereof.
67. The method of embodiment 65, wherein the additive component is an aromatic additive selected from butylated hydroxyanisole, eugenol, salicylaldehyde, acetophenone, methyl salicylate, and a combination thereof.
68. The method of embodiment 65, wherein the additive component is an acid-containing additive selected from itacoic acid, adipic acid, maleic acid, octanoic acid, ethyl maltol, ascorbic acid, levulinic acid, and a combination thereof.
69. The method of embodiment 65, wherein the additive component is an ester-containing additive selected from triethyl citrate, isobornyl acetate, propylene carbonate, ethyl lactate, and a combination thereof.
70. The method of embodiment 65, wherein the additive component is a glycol-containing additive selected from diethylene glycol monoethyl ether, ethylene glycol, monobutyl ether, and a combination thereof.
71. The method of any one of embodiments 64-70, wherein tert-butylhydroquinone and the additive component are present in a weight ratio of from about 1:10 to about 10:1.
72. The method of any one of embodiments 64-71, wherein the additive component is present in an amount of from about 1% to about 50% by weight based on the total weight of the composition.
73. The method of any one of embodiments 64-72, wherein the urease inhibitor composition further comprises a surfactant, a dispersant, an emulsifier, an antifoam agent, a stability agent, or a combination thereof.
74. A urease inhibitor composition comprising:
   tert-butylhydroquinone;
   an additive selected from an α,β-unsaturated carbonyl system-containing additive, an acid-containing additive, an ester-containing additive, an aromatic additive, a glycol-containing additive; and
   an organic solvent,
   wherein tert-butylhydroquinone and the additive component are present in synergistic amounts.
75. The composition of embodiment 74, wherein tert-butylhydroquinone is present in an amount of from about 0.1% to about 65% by weight based on the total weight of the composition.
76. The composition of embodiment 74, wherein the additive is present in an amount of from about 1% to about 50% by weight based on the total weight of the composition.
77. The composition of any one of embodiments 74-76, wherein tert-butylhydroquinone and the additive are present in a weight ratio of from about 1:10 to about 10:1.
78. The composition of any one of embodiments 74-77, wherein the organic solvent is selected from a sulfoxide, an aromatic solvent, a green solvent, a safe solvent, and a combination thereof.
79. The composition of any one of embodiments 74-78, wherein the organic solvent comprises dimethyl sulfoxide.
80. The composition of embodiment 79, wherein the organic solvent comprises dimethyl sulfoxide and xylene.
81. The composition of embodiment 80, wherein dimethyl sulfoxide and xylene are present at a weight ratio of from about 1:2 to about 2:1.
82. The composition of any one of embodiments 74-81, wherein the additive component is selected from an α,β-unsaturated carbonyl system-containing additive, an acid-containing additive, an ester-containing additive, an aromatic additive, a glycol-containing additive, and a combination thereof.
83. The composition of embodiment 82, wherein the additive component is an α,β-unsaturated carbonyl system-containing additive selected from citral, mesityl oxide, α-amylcinnamaldehyde, coumarin, and a combination thereof.
84. The composition of embodiment 82, wherein the additive component is an aromatic additive selected from butylated hydroxyanisole, eugenol, salicylaldehyde, acetophenone, methyl salicylate, and a combination thereof.
85. The composition of embodiment 82, wherein the additive component is an acid-containing additive selected from itacoic acid, adipic acid, maleic acid, octanoic acid, ethyl maltol, ascorbic acid, levulinic acid, and a combination thereof.
86. The composition of embodiment 82, wherein the additive component is an ester-containing additive selected from triethyl citrate, isobornyl acetate, propylene carbonate, ethyl lactate, and a combination thereof.
87. The composition of embodiment 82, wherein the additive component is a glycol-containing additive selected from diethylene glycol monoethyl ether, ethylene glycol, monobutyl ether, and a combination thereof.
88. The composition any one of embodiments 74-87, wherein the urease inhibitor composition further comprises a surfactant, a dispersant, an emulsifier, an antifoam agent, a stability agent, or a combination thereof.
89. The composition of one of embodiments 74-88, wherein at least about 50% of urease enzyme activity is being inhibited.

### V. EXAMPLES

It should be understood that the following Examples are provided by way of illustration only and nothing therein should be taken as a limiting.

### Example 1: Screening of Urease Inhibitor Compositions

Evaluation of tert-butylhydroquinone (tBHQ) in combination with an additive component was tested. Many different classes of potential urease inhibitor (UI) compounds were screened as potential additive components. For example, various groups such as phosphinic acids, pyrocatechol, hydroquinones, triazoles, coumarins, alpha-hydroxyketones, oximes, protocatechuic acid, butylated hydroxyanisole (BHA), butylated hydroxytoluene (BHT), phosphoramides and certain thio-compounds to name a few. tBHQ was chosen as the primary urease inhibitor due to its initial performance, availability, and safety rating. A couple of different modes of action (MOA) for UI compounds are proposed, such as, but not limited to, Ni(II) binding and mobile flap folding, as the primary modes.

These studies further investigated the performance in the field at higher levels (>10 qt/ton) of tBHQ and select additives such that the rate is compatible with commercial products, i.e., in the 3 qt/ton range. Synergistic additives as well as safer and greener solvent were identified, which are all commercially available at a scale of ton (and more).

### A. Materials and Protocols

tBHQ (main active ingredient (AI)), solvents, additives (co-Actives) were obtained from commercial vendors. Draeger tube protocol was developed and used soils from NCSU Ag research facility at Oxford, North Carolina. Samples were prepared by co-dissolution in the appropriate solvent by rolling on a sample roller for 2-4 hours at ambient temperature and allowed to stand over weekend to make sure there was no haziness and/or precipitate that developed. Typical sample size was 4-4.5 g in a 12 mL cylindrical glass vial. These clear (sometimes colored as light peach) solutions were applied on urea prills at 3 qts/ton (L, for low rate) and 6 qts/ton (H, for high rate). Readings were plotted as a graph where time is the independent variable and NH₃ recorded (on a linear Draeger scale) on the y-axis to generate, in general, “S” shaped outputs. UTC and urea controls, along with Formulation A (Agrotain®) and Formulation B (tBHQ in organic solvent were included for all rounds. Samples were stored at ambient for 6 months (or 12 months) to see any precipitates, thickening or haziness.

### B. Results and Discussions

The following candidates were tBHQ+[x co-Active+y Solvent] where x and y varied. Results of numerous rounds of evaluations were carried out and are discussed in more detail below. Data for ˜70 candidate evaluations are shown, including candidate numbers (i.e., UI #), chemical names and CAS Numbers. In general, a candidate displays good performance when its graph stays close to x-axis (implying lower volatilization). Solid lines are Low rates and broken lines are High rates; UTC is always closest to x-axis, urea control is generally the left most line in the graph, in addition to Agrotain® (Formulation A) and Formulation B There are multiple evaluations per round. Most experiments took 2 weeks to complete while, in case of better candidates, some experiments took 3 weeks (or 4 weeks) to complete. Longer periods of time of suppressing volatilization is a good indicator of expected superior performance.

### Round 1:

The following compounds were evaluated:

| Urease Inhibitor | | CAS No. of additive |
|---|---|---|
| Composition # | Reagents | component |
| UI #89 | tBHQ + isophorone | 78-59-1 |
| UI #90 | tBHQ + citral | 5392-40-5 |
| UI #91 | tBHQ + α- | 101-86-0 |
| | hexylcinnamaldehyde | |
| UI #92 | tBHQ + trans- | 14371-10-9 |
| | cinnamaldehyde | |
| UI #93 | tBHQ + mesityl oxide | 141-79-7 |
| UI #94 | tBHQ + diethyl maleate | 141-05-9 |

### Results:

TABLE 2

| Time (hrs) - | 16 | 24 | 40 | 48 | 67 | 89 | 115 | 140 | 159 | 183 | 205 | 234 | 254 |
|---|---|---|---|---|---|---|---|---|---|---|---|---|---|
| Soil, | 0 | 0 | 0 | 0 | 0 | 0 | 0 | 0 | 0.33 | 1.67 | 2 | 3.67 | 6.33 |
| untreated | | | | | | | | | | | | | |
| Urea | 0 | 0 | 5 | 23.3 | 150 | 150 | 150 | 150 | 150 | 150 | 150 | 150 | 150 |
| Formulation | 0 | 0 | 0 | 0 | 0 | 0 | 0 | 1.33 | 2.67 | 6 | 10.7 | 26 | 40.3 |
| A | | | | | | | | | | | | | |
| Formulation | 0 | 0 | 0 | 0 | 0 | 0 | 0 | 0.67 | 3 | 17.7 | 71.7 | 125.3 | 150 |
| B | | | | | | | | | | | | | |
| UI #89 | 0 | 0 | 0 | 0 | 0 | 0 | 3 | 44 | 124.7 | 150 | 150 | 150 | 150 |
| UI #90 | 0 | 0 | 0 | 0 | 0 | 0 | 4.67 | 69.3 | 101 | 101.3 | 102 | 116.7 | 150 |
| UI #91 | 0 | 0 | 0 | 0 | 0 | 0 | 1.33 | 7.67 | 80 | 150 | 150 | 150 | 150 |
| UI #92 | 0 | 0 | 0 | 0 | 0 | 0.67 | 3.33 | 86.7 | 150 | 150 | 150 | 150 | 150 |
| UI #93 | 0 | 0 | 0 | 0 | 0 | 0 | 1 | 33.7 | 90.7 | 150 | 150 | 150 | 150 |
| UI #94 | 0 | 0 | 0 | 0 | 0 | 0 | 1.67 | 57.3 | 145 | 150 | 150 | 150 | 150 |

### Round 2:

The following compounds were evaluated:

| Urease inhibitor | | CAS No. of additive |
|---|---|---|
| Composition # | Reagents | component |
| UI #93 | tBHQ + mesityl oxide | 141-79-7 |
| UI #95 | Mesityl oxide | 141-79-7 |
| UI #96 | α-amylcinnamaldehyde | 122-40-7 |
| UI #97 | tBHQ + α- | 122-40-7 |
| | amylcinnamaldehyde | |
| UI #98 | tBHQ + coumarin | 91-64-5 |
| UI #99 | tBHQ + ethyl sorbate | 2396-84-1 |

### Results:

TABLE 3

| Time (hrs) | 16 | 24 | 41 | 48 | 67 | 88 | 106 | 130 | 148 | 175 | 196 | 214 | 232 |
|---|---|---|---|---|---|---|---|---|---|---|---|---|---|
| Soil, | 0 | 0 | 0 | 0 | 0 | 0 | 0 | 0 | 0 | 0.33 | 0.67 | 1 | 2.67 |
| untreated | | | | | | | | | | | | | |
| Urea | 0 | 0 | 3 | 9.33 | 143.3 | 150 | 150 | 150 | 150 | 150 | 150 | 150 | 150 |
| Formulation | 0 | 0 | 0 | 0 | 0 | 0 | 0 | 0.33 | 1.67 | 3.33 | 4 | 6.67 | 9 |
| A | | | | | | | | | | | | | |
| Formulation | 0 | 0 | 0 | 0 | 0 | 0 | 0.67 | 13.3 | 64.3 | 101.3 | 102 | 104 | 107 |
| B | | | | | | | | | | | | | |
| UI #93 | 0 | 0 | 0 | 0 | 0 | 0 | 1.67 | 49.3 | 89.3 | 112.7 | 150 | 150 | 150 |
| Repeat | | | | | | | | | | | | | |
| UI #95 | 0 | 0 | 4 | 44.3 | 150 | 150 | 150 | 150 | 150 | 150 | 150 | 150 | 150 |
| UI #96 | 0 | 0 | 2 | 18 | 133.3 | 150 | 150 | 150 | 150 | 150 | 150 | 150 | 150 |
| UI #97 | 0 | 0 | 0.33 | 0.33 | 0.33 | 0.67 | 3 | 36 | 54.7 | 90 | 127.3 | 150 | 150 |
| UI #98 | 0 | 0 | 0 | 0 | 0 | 0 | 1 | 2 | 9 | 54.3 | 59.3 | 81.3 | 111 |
| UI #99 | 0 | 0 | 0 | 0 | 0 | 0 | 1 | 24 | 109 | 150 | 150 | 150 | 150 |

### Round 3:

The following compounds were evaluated

| | | CAS No. |
|---|---|---|
| Urease Inhibitor | | of additive |
| Composition # | Reagents | component |
| UI #100 | tBHQ + butylated | 25013-16-5 |
| | hydroxyanisole | |
| UI #101 | tBHQ + chalcone | 614-47-1 |
| UI #102 | tBHQ + phenylbutenone | 1896-62-4 |
| UI #103 | tBHQ + itaconic acid | 97-65-4 |
| UI #104 | tBHQ + thymol | 89-83-8 |
| UI #105 | tBHQ + vanillin | 121-33-5 |

### Results:

TABLE 4

| Time (hrs) | 16 | 23 | 41 | 50 | 64 | 88 | 107 | 131 | 149 | 173 | 197 | 220 | 244 |
|---|---|---|---|---|---|---|---|---|---|---|---|---|---|
| Soil, | 0 | 0 | 0 | 0 | 0 | 0 | 0 | 0 | 0 | 0.67 | 2.33 | 3.33 | 3.33 |
| untreated | | | | | | | | | | | | | |
| Urea | 0 | 0 | 6.33 | 45.3 | 150 | 150 | 150 | 150 | 150 | 150 | 150 | 150 | 150 |
| Formulation | 0 | 0 | 0 | 0 | 0 | 0 | 0 | 2.33 | 4.67 | 10 | 20 | 44 | 70 |
| A | | | | | | | | | | | | | |
| Formulation | 0 | 0 | 0 | 0 | 0 | 0 | 0 | 1.67 | 22.7 | 51.3 | 51.3 | 52 | 53.7 |
| B | | | | | | | | | | | | | |
| UI #100 | 0 | 0 | 0 | 0 | 0 | 0 | 0 | 10.7 | 43.3 | 100.7 | 150 | 150 | 150 |
| UI #101 | 0 | 0 | 0 | 0 | 0 | 4 | 101 | 114 | 141.7 | 150 | 150 | 150 | 150 |
| UI #102 | 0 | 0 | 0 | 0 | 0 | 0 | 2.33 | 31 | 87.3 | 150 | 150 | 150 | 150 |
| UI #103 | 0 | 0 | 0 | 0 | 0 | 0 | 0 | 1 | 3 | 28 | 110.3 | 150 | 150 |
| UI #104 | 0 | 0 | 0 | 0 | 0 | 0.67 | 45.7 | 100.7 | 110.7 | 141.7 | 150 | 150 | 150 |
| UI #105 | 0 | 0 | 0 | 0 | 0 | 0 | 7 | 109 | 136.7 | 150 | 150 | 150 | 150 |

### Round 4:

The following compounds were evaluated:

| | | CAS No. |
|---|---|---|
| Urease Inhibitor | | of additive |
| Composition # | Reagents | component |
| UI #106 | tBHQ + anisaldehyde | 123-11-5 |
| UI #107 | tBHQ + dimethyl succinate | 106-65-0 |
| UI #108 | tBHQ + eugenol | 97-53-0 |
| UI #109 | tBHQ + levulinic acid | 123-76-2 |
| UI #110 | tBHQ + salicylaldehyde | 90-02-8 |
| UI #111 | tBHQ + triethyl citrate | 77-93-0 |

### Results/Comments

TABLE 5

| Time (hrs) | 15 | 22 | 39 | 48 | 63 | 90 | 118 | 137 | 169 | 193 | 208 |
|---|---|---|---|---|---|---|---|---|---|---|---|
| Soil, | 0 | 0 | 0 | 0 | 0 | 0 | 0 | 0 | 0.33 | 1 | 2 |
| untreated | | | | | | | | | | | |
| Urea | 0 | 0 | 5 | 52.3 | 150 | 150 | 150 | 150 | 150 | 150 | 150 |
| Formulation | 0 | 0 | 0 | 0 | 0 | 0 | 0 | 1 | 6 | 9 | 13.7 |
| A | | | | | | | | | | | |
| Formulation | 0 | 0 | 0 | 0 | 0 | 0 | 15 | 39 | 53 | 58 | 65.7 |
| B | | | | | | | | | | | |
| UI #106 | 0 | 0 | 0 | 0 | 0 | 0 | 40 | 128.3 | 150 | 150 | 150 |
| UI #107 | 0 | 0 | 0 | 0 | 0 | 1 | 40 | 105 | 150 | 150 | 150 |
| UI #108 | 0 | 0 | 0 | 0 | 0 | 0 | 25 | 53 | 102 | 150 | 150 |
| UI #109 | 0 | 0 | 0 | 0 | 0 | 0 | 27.3 | 106 | 150 | 150 | 150 |
| UI #110 | 0 | 0 | 0 | 0 | 0 | 0 | 41.7 | 92 | 135 | 150 | 150 |
| UI #111 | 0 | 0 | 0 | 0 | 0 | 0 | 0.33 | 6 | 60 | 88.3 | 150 |

### Round 5

The following compounds were evaluated:

| | | CAS No. |
|---|---|---|
| Urease Inhibitor | | of additive |
| Composition # | Reagents | component |
| UI #112 | tBHQ + acetophenone | 98-86-2 |
| UI #113 | tBHQ + isobornyl acetate | 125-12-2 |
| UI #114 | tBHQ + dipropylene glycol | 34590-94-8 |
| | monomethyl ether | |
| UI #115 | tBHQ + propylene carbonate | 108-32-7 |
| UI #116 | tBHQ + tetraethylene glycol | 112-60-7 |

### Results:

TABLE 6

| Time (hrs) | 17 | 23 | 42 | 49 | 64 | 88 | 118 | 142 | 161 | 190 | 209 | 233 | 257 | 281 | 310 | 328 |
|---|---|---|---|---|---|---|---|---|---|---|---|---|---|---|---|---|
| Soil, | 0 | 0 | 0 | 0 | 0 | 0 | 0 | 0 | 0 | 0.67 | 2.33 | 2.67 | 9.33 | 12 | 15.3 | 22 |
| untreated | | | | | | | | | | | | | | | | |
| Urea | 0 | 0 | 1.67 | 11.7 | 128.3 | 150 | 150 | 150 | 150 | 150 | 150 | 150 | 150 | 150 | 150 | 150 |
| Formulation | 0 | 0 | 0 | 0 | 0 | 0 | 0 | 0 | 1 | 3 | 5.67 | 11.67 | 19.3 | 36 | 58 | 68.7 |
| A | | | | | | | | | | | | | | | | |
| Formulation | 0 | 0 | 0 | 0 | 0 | 0 | 0 | 0 | 0 | 0 | 0.33 | 1.33 | 2.33 | 4.33 | 16.3 | 27 |
| B | | | | | | | | | | | | | | | | |
| UI #112 | 0 | 0 | 0 | 0 | 0 | 0 | 1.33 | 20 | 94 | 108.3 | 108.3 | 109.3 | 110.7 | 112.7 | 123.3 | 138.3 |
| UI #113 | 0 | 0 | 0 | 0 | 0 | 0 | 0 | 34.3 | 52 | 74.33 | 101.3 | 114 | 150 | 150 | 150 | 150 |
| UI #114 | 0 | 0 | 0 | 0 | 0 | 0 | 0 | 1.67 | 10 | 143.3 | 150 | 150 | 150 | 150 | 150 | 150 |
| UI #115 | 0 | 0 | 0 | 0 | 0 | 0 | 0 | 0.67 | 1.33 | 3.33 | 11.67 | 65 | 101.7 | 102.3 | 106.7 | 107.3 |
| UI #116 | 0 | 0 | 0 | 0 | 0 | 0 | 0 | 2 | 16.3 | 78.7 | 135 | 150 | 150 | 150 | 150 | 150 |

### Round 6

The following compounds were evaluated:

| | | CAS No. |
|---|---|---|
| Urease Inhibition | | of additive |
| Composition # | Reagents | component |
| UI #117 | tBHQ + adipic acid | 124-04-9 |
| UI #118 | tBHQ + maleic acid | 110-16-7 |
| UI #119 | tBHQ + malic acid | 6915-15-7 |
| UI #120 | tBHQ + octanoic acid | 124-07-2 |
| UI #121 | tBHQ + sorbic acid | 110-44-1 |
| UI #122 | tBHQ + succinic acid | 110-15-6 |

### Results:

TABLE 7

| Time (hrs) | 16 | 22 | 41 | 48 | 64 | 88 | 120 | 140 | 163 | 191 | 212 | 232 | 264 | 288 | 312 | 333 | 353 |
|---|---|---|---|---|---|---|---|---|---|---|---|---|---|---|---|---|---|
| Soil, | 0 | 0 | 0 | 0 | 0 | 0 | 0 | 0 | 0.33 | 2.33 | 2.33 | 3 | 5 | 16 | 24.3 | 36 | 42 |
| untreated | | | | | | | | | | | | | | | | | |
| Urea | 0 | 0 | 5.67 | 33.3 | 150 | 150 | 150 | 150 | 150 | 150 | 150 | 150 | 150 | 150 | 150 | 150 | 150 |
| Formulation | 0 | 0 | 0 | 0 | 0 | 0 | 0 | 0 | 0 | 0 | 2.33 | 3 | 10 | 20 | 36.7 | 46.7 | 57.3 |
| A | | | | | | | | | | | | | | | | | |
| Formulation | 0 | 0 | 0 | 0 | 0 | 0 | 0 | 0 | 3.67 | 39 | 100 | 102 | 101 | 101 | 101.7 | 103.3 | 120 |
| B | | | | | | | | | | | | | | | | | |
| UI #117 | 0 | 0 | 0 | 0 | 0 | 0 | 0 | 0 | 1 | 1.33 | 10.3 | 39 | 56 | 67 | 80 | 103.3 | 148.3 |
| UI #118 | 0 | 0 | 0 | 0 | 0 | 0 | 0 | 1 | 30.7 | 52.3 | 87.3 | 145 | 150 | 150 | 150 | 150 | 150 |
| UI #119 | 0 | 0 | 0 | 0 | 0 | 0 | 0 | 0 | 1.67 | 50.3 | 53.3 | 90 | 150 | 150 | 150 | 150 | 150 |
| UI #120 | 0 | 0 | 0 | 0 | 0 | 0 | 0.33 | 2 | 7.67 | 53 | 77.7 | 102.3 | 108 | 133.3 | 150 | 150 | 150 |
| UI #121 | 0 | 0 | 0 | 0 | 0 | 0 | 3.33 | 51.3 | 79.7 | 107.3 | 135 | 150 | 150 | 150 | 150 | 150 | 150 |
| UI #122 | 0 | 0 | 0 | 0 | 0 | 0 | 0 | 0.33 | 4.33 | 87.7 | 145 | 150 | 150 | 150 | 150 | 150 | 150 |

### Round 7

The following compounds were evaluated:

| | | CAS No. |
|---|---|---|
| Urease Inhibitor | | of additive |
| Composition # | Reagents | component |
| UI # 123 | tBHQ + 3,3-dimethylacrylic acid | 541-47-9 |
| UI # 124 | tBHQ + dimethyl sulfone | 67-71-0 |
| UI # 125 | tBHQ + ethyl lactate | 97-64-3 |
| UI # 126 | tBHQ + ethyl maltol | 4940-11_8 |
| UI # 127 | tBHQ + 85% lactic acid | 50-21-5 |
| UI # 128 | tBHQ + (L)-tartaric acid | 87-69-4 |

### Results/Comments:

TABLE 8

| Time (hrs) | 17 | 24 | 42 | 48 | 65 | 90 | 117 | 145 | 162 | 186 | 210 | 232 |
|---|---|---|---|---|---|---|---|---|---|---|---|---|
| Soil, | 0 | 0 | 0 | 0 | 0 | 0 | 0 | 0 | 0 | 0 | 1.33 | 3.67 |
| untreated | | | | | | | | | | | | |
| Urea | 0 | 0 | 1.67 | 12.3 | 126.7 | 150 | 150 | 150 | 150 | 150 | 150 | 150 |
| Formulation | 0 | 0 | 0 | 0 | 0 | 0 | 0 | 1.33 | 4 | 18 | 38 | 52.7 |
| A | | | | | | | | | | | | |
| Formulation | 0 | 0 | 0 | 0 | 0 | 0 | 0 | 0 | 2.33 | 35.3 | 103 | 134.3 |
| B | | | | | | | | | | | | |
| UI #123 | 0 | 0 | 0 | 0 | 0 | 0 | 7.33 | 136.7 | 150 | 150 | 150 | 150 |
| UI #124 | 0 | 0 | 0 | 0 | 0 | 0 | 38.3 | 133.3 | 150 | 150 | 150 | 150 |
| UI #125 | 0 | 0 | 0 | 0 | 0 | 0 | 1 | 50.7 | 52.3 | 95.3 | 101 | 102.3 |
| UI #126 | 0 | 0 | 0 | 0 | 0 | 0 | 0 | 52 | 71 | 120 | 150 | 150 |
| UI #127 | 0 | 0 | 0 | 0 | 0 | 0 | 1.67 | 99.3 | 133.3 | 133.3 | 150 | 150 |
| UI #128 | 0 | 0 | 0 | 0 | 0 | 0 | 1 | 103.3 | 150 | 150 | 150 | 150 |

### Round 8

The following compounds were evaluated:

| | | CAS No. |
|---|---|---|
| Urease Inhibitor | | of additive |
| Compositions # | Reagents | component |
| UI # 129 | tBHQ + L-ascorbic acid | 50-81-7 |
| UI # 130 | tBHQ + butyl lactate | 138-22-7 |
| UI # 131 | tBHQ + (+)-diethyl L-tartarate | 87-91-2 |
| UI # 132 | tBHQ + poly(isobutylene-alt-maleic | 26426-80-2 |
| | anhydride) | |
| UI # 133 | tBHQ + 2,6-pyridinedicarboxylic | 499-83-2 |
| | acid | |
| UI # 134 | tBHQ + 4-carboxybenzaldehyde | 619-66-9 |

### Results:

TABLE 9

| Time (hrs) | 16 | 24 | 40 | 48 | 64 | 90 | 120 | 141 | 160 | 184 | 208 |
|---|---|---|---|---|---|---|---|---|---|---|---|
| Soil, untreated | 0 | 0 | 0 | 0 | 0 | 0 | 0 | 0 | 0 | 0.33 | 1.67 |
| Urea | 0 | 0 | 3.33 | 62 | 150 | 150 | 150 | 150 | 150 | 150 | 150 |
| Formulation A | 0 | 0 | 0 | 0 | 0 | 0 | 6 | 30.7 | 50 | 50 | 51 |
| Formulation B | 0 | 0 | 0 | 0 | 0 | 0 | 0 | 0 | 1.67 | 32 | 112 |
| UI #129-High | 0 | 0 | 0 | 0 | 0 | 0 | 1 | 5 | 76.7 | 150 | 150 |
| UI #130-High | 0 | 0 | 0 | 0 | 0 | 0 | 9.67 | 118.3 | 150 | 150 | 150 |
| UI #131-High | 0 | 0 | 0 | 0 | 0 | 0 | 33 | 136.7 | 150 | 150 | 150 |
| UI #132-High | 0 | 0 | 0 | 0 | 0 | 0 | 16.7 | 112 | 148.3 | 150 | 150 |
| UI #133-High | 0 | 0 | 0 | 0 | 0 | 0 | 9.67 | 100 | 150 | 150 | 150 |
| UI #134-High | 0 | 0 | 0 | 0 | 0 | 0 | 41 | 106.7 | 136.7 | 150 | 150 |

### Round 9

The following compounds were evaluated:

| Urease Inhibitor | | |
|---|---|---|
| Composition | Reagents | CAS No. |
| UI # 135 | tBHQ + t-bubenzoic acid | 98-73-7 |
| UI # 136 | tBHQ + diacetone alcohol | 123-42-2 |
| UI # 137 | tBHQ + diethyl adipate | 141-28-6 |
| UI # 138 | tBHQ + diethylene glycol | 112-34-5 |
| | monobutyl ether | |
| UI # 139 | tBHQ + diethylene glycol | 111-90-0 |
| | monoethyl ether | |
| UI # 140 | Ethylene glycol monobutyl ether | 111-76-2 |
| UI # 141 | tBHQ + isophorone | 78-59-1 |

### Results

TABLE 10

| Time (hrs) | 18 | 24 | 43 | 48 | 67 | 96 | 120 | 139 | 163 | 187 | 211 | 235 |
|---|---|---|---|---|---|---|---|---|---|---|---|---|
| Soil, untreated | 0 | 0 | 0 | 0 | 0 | 0 | 0 | 0 | 0 | 0 | 0 | 0 |
| Urea | 0 | 0 | 8.67 | 40.7 | 150 | 150 | 150 | 150 | 150 | 150 | 150 | 150 |
| Formulation A | 0 | 0 | 0 | 0 | 0 | 0 | 1.33 | 4 | 16 | 48.7 | 95 | 145 |
| Formulation B | 0 | 0 | 0 | 0 | 0 | 0 | 0 | 1.67 | 26.7 | 101 | 114 | 150 |
| UI #135 | 0 | 0 | 0 | 0 | 0 | 2.33 | 50.7 | 69.7 | 101 | 126 | 150 | 150 |
| UI #136 | 0 | 0 | 0 | 0 | 0 | 0 | 5.67 | 68.7 | 136.7 | 150 | 150 | 150 |
| UI #137 | 0 | 0 | 0 | 0 | 0 | 0 | 1.67 | 24.7 | 109 | 150 | 150 | 150 |
| UI #138 | 0 | 0 | 0 | 0 | 0 | 0.33 | 27.33 | 53 | 105 | 150 | 150 | 150 |
| UI #139 | 0 | 0 | 0 | 0 | 0 | 0 | 1.33 | 45.7 | 55 | 101.7 | 136.7 | 150 |
| UI #140 | 0 | 0 | 0 | 0 | 0 | 0.33 | 25.67 | 70.7 | 101.7 | 124 | 150 | 150 |
| UI #141 | 0 | 0 | 0 | 0 | 0 | 0 | 1.67 | 48 | 150 | 150 | 150 | 150 |

### Round 10

The following compounds were evaluated:

| | | CAS No. |
|---|---|---|
| Urease Inhibitor | | of additive |
| Composition # | Reagents | component |
| UI # 142 | tBHQ + anisaldehyde | 123-11-5 |
| UI # 143 | tBHQ + DBE-4 | 106-65-0 |
| UI # 144 | tBHQ + levulinic acid | 123-76-2 |
| UI # 145 | tBHQ + PGME | 107-98-2 |
| UI # 146 | tBHQ + PGMEA | 108-65-6 |
| UI # 147 | tBHQ + methyl salicylate | 119-36-8 |
| UI # 148 | tBHQ + salicylaldehyde | 90-02-8 |

### Results:

TABLE 11

| Time (hrs) | 18 | 24 | 42 | 48 | 66 | 90 | 120 | 141 | 162 |
|---|---|---|---|---|---|---|---|---|---|
| Soil, | 0 | 0 | 0 | 0 | 0 | 0 | 0 | 0.33 | 0.67 |
| untreated | | | | | | | | | |
| Urea | 0 | 0 | 125 | 150 | 150 | 150 | 150 | 150 | 150 |
| Formulation A | 0 | 0 | 0 | 0 | 0 | 0 | 0.33 | 0 | 1.7 |
| Formulation B | 0 | 0 | 0 | 0 | 0 | 0 | 10.3 | 63.7 | 100.7 |
| UI #142- | 0 | 0 | 0 | 0 | 0 | 0 | 0 | 0.67 | 6.3 |
| High | | | | | | | | | |
| UI #143- | 0 | 0 | 0 | 0 | 0 | 0 | 0.67 | 12.7 | 57.7 |
| High | | | | | | | | | |
| UI #144- | 0 | 0 | 0 | 0 | 0 | 0.33 | 12 | 48 | 67 |
| High | | | | | | | | | |
| UI #145- | 0 | 0 | 0 | 0 | 0 | 0 | 62.3 | 100.7 | 101.3 |
| High | | | | | | | | | |
| UI #146- | 0 | 0 | 0 | 0 | 0 | 0 | 17.3 | 95.3 | 101.7 |
| High | | | | | | | | | |
| UI #147- | 0 | 0 | 0 | 0 | 0 | 0 | 36.7 | 50.3 | 51 |
| High | | | | | | | | | |
| UI #148- | 0 | 0 | 0 | 0 | 0 | 1 | 35 | 50.7 | 51.3 |
| High | | | | | | | | | |

| Time (hrs) | 187 | 210 | 234 | 266 | 288 | 312 | 330 | 354 | 381 |
|---|---|---|---|---|---|---|---|---|---|
| Soil, | 1.7 | 5 | 12 | 30 | 36.7 | 43.3 | 47.7 | 56.7 | 63.3 |
| untreated | | | | | | | | | |
| Urea | 150 | 150 | 150 | 150 | 150 | 150 | 150 | 150 | 150 |
| Formulation A | 2.3 | 2.7 | 4 | 10 | 16.7 | 30 | 40 | 50.67 | 72 |
| Formulation B | 100.7 | 101 | 103.7 | 150 | 150 | 150 | 150 | 150 | 150 |
| UI #142- | 51.7 | 53 | 55.3 | 103.3 | 120 | 140 | 150 | 150 | 150 |
| High | | | | | | | | | |
| UI #143- | 103.3 | 145 | 150 | 150 | 150 | 150 | 150 | 150 | 150 |
| High | | | | | | | | | |
| UI #144- | 100.3 | 100.3 | 100.3 | 100.7 | 101 | 106.7 | 112.7 | 126.7 | 150 |
| High | | | | | | | | | |
| UI #145- | 101.3 | 108 | 145 | 150 | 150 | 150 | 150 | 150 | 150 |
| High | | | | | | | | | |
| UI #146- | 106.3 | 135 | 150 | 150 | 150 | 150 | 150 | 150 | 150 |
| High | | | | | | | | | |
| UI #147- | 51.7 | 53 | 74 | 103.3 | 107 | 113.33 | 122 | 136.7 | 150 |
| High | | | | | | | | | |
| UI #148- | 53 | 74 | 101.7 | 121.7 | 150 | 150 | 150 | 150 | 150 |
| High | | | | | | | | | |

### Round 11

The following compounds were evaluated:

| | | CAS No. |
|---|---|---|
| Urease Inhibitor | | of additive |
| Composition # | Reagents | component |
| UI # 149 | tBHQ + citral | 5392-40-5 |
| UI # 150 | tBHQ + MOx | 141-79-7 |
| UI # 151 | tBHQ + coumarin | 91-64-5 |
| UI # 152 | tBHQ + itaconic acid | 97-65-4 |
| UI # 153 | tBHQ + triethyl citrate | 77-93-0 |
| UI # 154 | tBHQ + acetophenone | 98-86-2 |
| UI # 155 | tBHQ + isobornyl acetate | 125-12-2 |

### Results:

TABLE 12

| Time (hrs) | 16 | 24 | 40 | 48 | 64 | 88 | 135 | 145 | 160 | 184 | 208 | 232 | 256 |
|---|---|---|---|---|---|---|---|---|---|---|---|---|---|
| Soil, | 0 | 0 | 0 | 0 | 0 | 0 | 0 | 0 | 0 | 0.6 | 1.6 | 2.4 | 5.6 |
| untreated | | | | | | | | | | | | | |
| Urea | 0 | 0 | 12 | 36 | 125.4 | 150 | 150 | 150 | 150 | 150 | 150 | 150 | 150 |
| Formulation | 0 | 0 | 0 | 0 | 0 | 2.8 | 12 | 13.6 | 15.8 | 25.8 | 41.6 | 61.4 | 72.6 |
| A | | | | | | | | | | | | | |
| Formulation | 0 | 0 | 0 | 0 | 0 | 0 | 1.4 | 2 | 9.2 | 91.2 | 117.6 | 124.4 | 148 |
| B | | | | | | | | | | | | | |
| UI #149 | 0 | 0 | 0 | 0 | 0 | 0 | 25 | 77.6 | 137.6 | 150 | 150 | 150 | 150 |
| UI #150 | 0 | 0 | 0 | 0 | 0 | 0 | 7.8 | 12.8 | 41.4 | 102.2 | 150 | 150 | 150 |
| UI #151 | 0 | 0 | 0 | 0 | 0 | 0 | 14.6 | 54.6 | 104.6 | 132.4 | 150 | 150 | 150 |
| UI #152 | 0 | 0 | 0 | 0 | 0 | 0 | 42 | 74 | 113.4 | 142 | 150 | 150 | 150 |
| UI #153 | 0 | 0 | 0 | 0 | 0 | 0 | 10.4 | 33.6 | 102 | 131.2 | 150 | 150 | 150 |
| UI #154 | 0 | 0 | 0 | 0 | 0 | 0 | 2.2 | 10 | 56.2 | 112 | 147 | 150 | 150 |
| UI #155 | 0 | 0 | 0 | 0 | 0 | 0 | 8.8 | 23.8 | 72.8 | 141 | 150 | 150 | 150 |

### Round 12

The following compounds were evaluated:

| | | CAS No. |
|---|---|---|
| Urease Inhibitor | | of additive |
| Composition # | Reagents | component |
| UI # 156 | tBHQ + adipic acid | 124-04-9 |
| UI # 157 | tBHQ + maleic acid | 110-16-7 |
| UI # 158 | tBHQ + malic acid | 6915-15-7 |
| UI # 159 | tBHQ + octanoic acid | 124-07-2 |
| UI # 160 | tBHQ + salicylic acid | 69-72-7 |
| UI # 161 | tBHQ + levulinic acid | 123-76-2 |
| UI # 162 | tBHQ + L-ascorbic acid | 50-81-7 |

### Results:

TABLE 13

| Time (hrs) | 15 | 23 | 39 | 48 | 66 | 90 | 111 | 138 | 159 | 192 | 216 | 239 | 260 | 283 | 304 | 327 | 357 | 375 |
|---|---|---|---|---|---|---|---|---|---|---|---|---|---|---|---|---|---|---|
| Soil, | 0 | 0 | 0 | 0 | 0 | 0 | 0 | 0 | 0.4 | 1.4 | 2 | 6.4 | 8.4 | 14.4 | 16.2 | 23 | 26.4 | 28.4 |
| untreated | | | | | | | | | | | | | | | | | | |
| Urea | 0 | 0 | 31 | 118 | 150 | 150 | 150 | 150 | 150 | 150 | 150 | 150 | 150 | 150 | 150 | 150 | 150 | 150 |
| Formulation | 0 | 0 | 0 | 0 | 0 | 0 | 1.4 | 3 | 5.6 | 10.6 | 15.2 | 18.6 | 22.8 | 27 | 32.4 | 38.8 | 44.4 | 49.2 |
| A | | | | | | | | | | | | | | | | | | |
| Formulation | 0 | 0 | 0 | 0 | 0 | 0 | 0.2 | 0.6 | 0.6 | 1.6 | 3 | 6 | 13 | 21 | 28.2 | 43.6 | 56 | 58 |
| B | | | | | | | | | | | | | | | | | | |
| UI #156 | 0 | 0 | 0 | 0 | 0 | 0 | 2 | 12.6 | 32 | 33 | 34.2 | 35 | 37.4 | 43.2 | 51.4 | 83.2 | 124.4 | 124.8 |
| UI #157 | 0 | 0 | 0 | 0 | 0 | 0 | 0 | 0 | 0 | 1 | 2 | 2.6 | 7.2 | 11.8 | 16.2 | 20.2 | 25.2 | 30 |
| UI#158 | 0 | 0 | 0 | 0 | 0 | 0 | 0 | 0.4 | 1.4 | 5.2 | 10.4 | 28.6 | 46.6 | 61.4 | 71 | 72.8 | 78.4 | 81.6 |
| UI #159 | 0 | 0 | 0 | 0 | 0 | 0 | 0 | 0.6 | 1.8 | 3.6 | 7.2 | 10.4 | 14.6 | 22.8 | 26.8 | 31.2 | 36.8 | 42.4 |
| UI #160 | 0 | 0 | 0 | 0 | 0 | 0 | 0.8 | 7.4 | 20 | 33.6 | 34.4 | 47.6 | 65.4 | 72 | 83.2 | 94.4 | 96 | 100 |
| UI #161 | 0 | 0 | 0 | 0 | 0 | 0 | 0 | 0.2 | 0.6 | 3.2 | 7.2 | 13.6 | 24.4 | 39.4 | 45.4 | 51 | 55.2 | 57.2 |
| UI #162 | 0 | 0 | 0 | 0 | 0 | 0 | 0 | 0 | 0.8 | 0.6 | 1.4 | 4 | 9.2 | 21 | 36.6 | 40.8 | 46 | 52.4 |

### Example 2: Biometer Type Volatilization Study

The aim of this study was to compare the magnitude of NH₃ volatilization from soils fertilized with urea that received different treatments.

### 1. Materials and Methods

### 1.1. Ammonia Volatilization Experiment

A laboratory trial was performed to compare the rate and cumulative amount of ammonia volatilization. The used soil (loamy sand) was sampled, dried at 40° C., and ground to pass a 2 mm-mesh sieve. To characterize the soil, different physicochemical properties were measured (Table 14): exchangeable bases (Ca⁺², K⁺, Mg⁺², Na⁺) (Haby et al., 1990), cation exchange capacity (CEC) (Chapman, 1965), soil organic matter (SOM) (Walkley y Black, 1934), pH (1:2.5 soil to water ratio), initial ammonium and nitrate content (Bremner and Keeney, 1965), and soil texture (Bouyoucos, 1963). To determine the bulk density of the 2-mm sample, a 1 L container was filled with soil and weighed.

TABLE 14
Physiochemical properties of the soil
used in the incubation experiment

| Soil property | Units | Value |
|---|---|---|
| Organic matter | g kg⁻¹ | 20.8 |
| pH | | 5.24 |
| Electric conductivity | mmhos cm⁻¹ | 0.27 |
| CEC | meq 100 g⁻¹ | 10.2 |
| Exchangeable Ca⁺² | meq 100 g⁻¹ | 3.5 |
| Exchangeable Mg⁺² | meq 100 g⁻¹ | 0.89 |
| Exchangeable Na⁺ | meq 100 g⁻¹ | 0.27 |
| Exchangeable K⁺ | meq 100 g⁻¹ | 1.13 |
| Sum bases | meq 100 g⁻¹ | 5.79 |
| Electric condictivity | mmhos cm⁻¹ | 0.27 |
| Base saturation | % | 56.7 |
| Sand | g kg⁻¹ | 810 |
| Silt | g kg⁻¹ | 104 |
| Clay | g kg⁻¹ | 86 |
| N—NO₃⁻ | mg kg⁻¹ | 19.6 |
| N—NH₄⁺ | mg kg⁻¹ | 14 |
| Bulk density | g cm⁻³ | 1.23 |
| Water holding | cm³ cm⁻³ | 0.42 |
| capacity | | |

The experiment consisted of 80 experimental units, composed of 1.3 L containers (diffusion chambers). An 800-g soil sample was weighted into each container. Half of the soils were thoroughly mixed with reagent grade micronized CaCO₃ to increase its base saturation from 57% to 70% (the CaCO₃ rate was equivalent to 1.6 Mg ha⁻¹). The soil in all containers was moistened with demineralized water to increase its water content to 70% of the water holding capacity. The water was applied gradually with a spray bottle while mixing the soil to ensure a homogeneous moistening. The diffusion chambers were hermetically closed and kept in an incubator at 25° C. for 10 days. During the pre-incubation, the chambers were opened every two days to avoid anoxic conditions.

After the pre-incubation, the fertilization treatments described in Table 15 were applied, with four replications per treatment. To this end, the fertilized treatments received urea at a 1500 mg N kg⁻¹ rate. The fertilizer was homogenously applied to the soil surface.

TABLE 15
N-fertilizer treatments and their identification names

| | |
|---|---|
| CaCO₃ | +CaCO₃ |

| | | |
|---|---|---|
| Commercial granulated | T1 | T1Lime |
| urea | | |
| Control without application | T2 | T2Lime |
| of urea to the soil | | |
| Urea treated with | T3 | T3Lime |
| Formulation C at 1.5 L | | |
| Mg − 1 | | |
| Urea treated with | T4 | T4Lime |
| Formulation Cat 2.0 L | | |
| Mg − 1 | | |
| Urea treated with | T5 | T5Lime |
| Formulation D at 1.5 L | | |
| Mg − 1 | | |
| Urea treated with | T6 | T6Lime |
| Formulation D at 2.0 L | | |
| Mg − 1 | | |
| Urea treated with | T7 | T7Lime |
| Formulation A at 2.0 L | | |
| Mg − 1 | | |
| Urea treated with | T8 | T8Lime |
| Formulation A at 3.0 L | | |
| Mg − 1 | | |
| Urea treated with | T9 | T9Lime |
| Formulation B at 7.0 L | | |
| Mg − 1 | | |
| Urea treated with | T10 | T10Lime |
| Formulation Bat 14.0 L | | |
| Mg − 1 | | |

A 50-ml plastic container with 20 ml of 1N NaOH (i.e., NH₃ trap) was placed inside each experimental unit. These traps were placed over a plastic tripod to allow gas exchange in all the soil surface. The diffusion chambers were hermetically closed and randomly placed in an incubator at 25° C. At different sampling moments (1, 2, 3, 4, 5, 7, 9, 11, 15, 19, 23, and 30 days after the application of the fertilizer) the traps were replaced. The extracted traps were immediately covered with a lid and stored at 4° C. until they were analysed for NH₄⁺ (less than 3 hours after the traps were replaced). The determination of NH₄⁺ concentration in the traps was performed by steam micro-distillation (Bremner and Keeney, 1965).

Since none of the fertilized treatments presented NH₃ volatilization values equal or lower to T2 (Control) after day 11, data collection continued throughout the 30-day incubation period for all treatments. After the end of the experiment, the soil was dried at 40° C. and ground to pass a 2-mm sieve. Afterwards, soil pH (1:2.5 soil to water ratio) and N—NH₄⁺ and N—NO₃⁻ concentrations (Bremner and Keeney, 1965) were determined in these soil samples.

### 1.2. Data Analysis

The experimental design was a randomized block (DBC) with two factors (fertilization treatment and liming). Results were analysed by analysis of variance to determine differences among treatments. Subsequently, treatment means were compared using the Tukey test (p<0.05). The ammonia volatilization results were compared in two different ways. First, the ammonia volatilization rates at each moment were compared. These rates were calculated as the amount of N—NH₃ in a trap at a moment X divided by the time (d) elapsed between moment X and moment X−1. Secondly, the cumulative N volatilized at each moment was calculated by subsequently adding the amount of N—NH₃ in time at each experimental unit.

To determine the proportion of N from the fertilizer that was recovered at the end of the experiment either as mineral N or as volatilized N, the following N balance was performed:

$$\% Fertilizer recovered = \frac{\begin{matrix}( Final mineral N + Volatilized N - \\ Initial mineral N - Mineralized N ) \times 100\end{matrix}}{Fertilizer N}$$

The N mineralization obtained in the Control treatment (T2) was used for the rest of the treatments, since in fertilized treatments the N derived from mineralization cannot be discriminated without performing isotopic dilution analysis. Therefore, by using the same mineralization results in all the treatments, no priming effect occurred in the fertilized ones.

### 2. Results and Discussion

2.1. Soil Mineral N after 30 Days of Incubation

The N—NH₄⁺ concentration of the soils after the incubation period was unaffected by liming (Table 16). However, N—NH₄⁺ concentration increased with fertilizer application as compared with T2 (Control). Among fertilized treatments, only T7 and T10 presented contrasting N—NH₄⁺ concentration, since the latter presented 14% more N—NH₄⁺ than T7.

The treatments that received lime presented a greater N—NO₃— concentration than those that did not receive lime (104.6 and 87.6 mg kg-1, respectively) (Table 16). However, this difference was not manifested in the total mineral N, since N—NO₃⁻ represented only 11% of the mineral N in the fertilized treatments. The N—NO₃⁻ concentration was generally greater in fertilized treatments as compared with T2 (+59%), except for T9 and T10 which did not differ from the control treatment.

TABLE 16
Results from the analysis of variance for N—NH₄⁺,
N—NO₃⁻, and mineral N (N—NH₄⁺ + N—NO₃⁻)
(mg kg⁻¹) measured at the end of the incubation experiment.
p-value

| | N—NH₄⁺ | N—NO₃⁻ | Mineral N |
|---|---|---|---|
| Model | <0.0001 | <0.0001 | <0.0001 |
| Treatment | <0.0001 | <0.0001 | <0.0001 |
| Lime | 0.9544 | 0.0001 | 0.2475 |
| Treatment | 0.4246 | 0.6595 | 0.3258 |
| *Lime | | | |

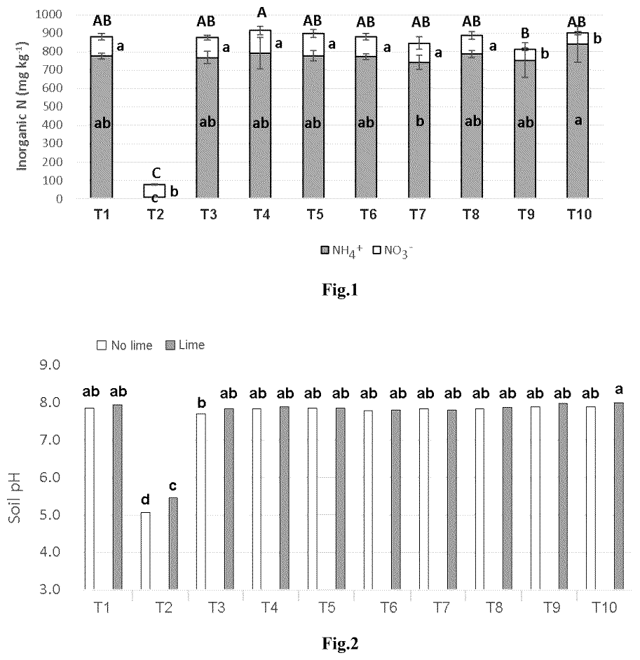

The soil N—NH₄⁺ concentration at T2 after the 30-day incubation was 45 times lower than the initial one (Table 13, FIG. 1). Contrarily, N—NO₃⁻ concentration at T2 increased 2.5 times during the incubation period. As a result, it can be calculated that the amount of N mineralized in the Control treatment during the incubation was 43 mg N per kg soil.

2.2. Soil pH after 30 Days of Incubation

A significant interaction between fertilization treatments and liming on soil pH was observed (Table 17). Liming increased soil active acidity only at the unfertilized treatment, where soil pH was 8% greater at T2Lime as compared with T2 (FIG. 2). Fertilized treatments presented, on average, a soil pH 55% greater than T2 as a result of the hydrolysis of the urea, which consumes protons, increasing soil pH:

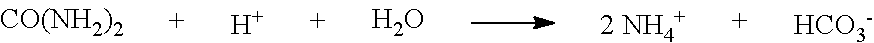

No effect of liming on pH was observed in the fertilized treatments. In this sense, an increase in soil pH decreases urease activity (Cabrera et al., 1991). Therefore, the lack of effect of liming on pH in the fertilized treatments is a result of 1) the greater effect of urea hydrolysis on soil pH masking the effect of liming, and/or 2) an interaction between liming and urea hydrolysis, which results in the effects of both processes on soil pH not being additive.

TABLE 17
Results from the analysis of variance
for pH measured at the end of the incubation
p-value

| | |
|---|---|
| Model | <0.0001 |
| Treatment | <0.0001 |
| Lime | 0.0005 |
| Treatment | 0.0122 |
| *Lime | |

Among fertilized treatments, only T10Lime and T3 had different pH values, since the former presented a slightly greater pH (+3.7%) than the latter. The most obvious difference between treatments is the application of lime. However, liming cannot be acknowledged as the main cause of the contrasting pH between T10Lime and T3, since the application of CaCO₃ did not affect pH at any other fertilized treatments. The difference between these treatments is related to the observed differences in their N—NO₃⁻ concentration. T10Lime presented the lowest N—NO₃⁻ concentration from all fertilized treatments (FIG. 15) demonstrating that the process of nitrification was efficiently limited. Considering that nitrification results in the release of protons that can partially compensate the effect of liming and/or urea hydrolysis on soil pH, changes in the nitrification rate partially explains the differences in soil pH between treatments.

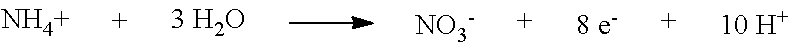

### 2.3. N—NH₃ Volatilization Rate

The results from the NH₃ volatilization rate study are as follows. At Day 1, T1Lime emitted 30 times more NH₃ than the average of the rest of the treatments (Table 18). On Day 2, the emissions increased in all treatments except for T2 (Control), T8, and T9, where no effect of liming was observed. Also on that day, T3, T5, and T7 (which were treated with 1.5, 1.5, and 2 L Mg⁻¹ of the corresponding products, respectively) emitted more than twice the NH₃ compared to the amount of NH₃ emitted by treatments where the products were applied at a greater rate (2, 2, and 3 L Mg⁻¹, for T4, T6, and T8, respectively). Therefore, at early stages after the application of the fertilizer, the rate of product applied to urea is an important factor as was observed in the application of the three out of four evaluated products (Formulation C, Formulation D, and Formulation A). Furthermore, even with the greater application rates of these products, these products were still unable to reduce NH₃ volatilization as efficiently as Formulation B.

At Day 3, the effects of fertilizer and liming on NH₃ volatilization rate were significant (Table 17). Here, the general trend of reducing NH₃ volatilization was the opposite as of the previously observed results. The limed soils, which tended to emit more NH₃ during Days 1 and 2, now presented an 8% lower emission rate. Also, treatments where the urea was not treated (T1) presented a lower NH₃ emission rate compared to T3, T4, T5, T6, T7, and T8. As in previous days, T9 and T10 did not differ from T2. Until Day 3, the content of the traps turned slightly pink when NaOH (50% w/w) was added during the quantification of NH₃. This observation, together with the strong odor of treatments that received Formulation B, indicates that this product is volatile and the resulting gas is soluble in the H₂SO₄ traps.

At Day 4, no effect of liming was observed (Table 18). From the evaluated treatments, T8 exhibited an emission rate that was 70% greater than T6 (which did not differ from T1), and T3, T4, T5, and T7 exhibited values between the two treatments (i.e., T8 and T6). Also, T9 and T10 had lower emission rates which did not differ from T2. At Day 5 the magnitude of the differences between treatments began to decrease, with T6 having a 30% greater NH₃ emission compared to T7, while T1, T3, T4, T5, and T8, exhibited values between those two treatments (i.e., T6 and T7). Again, T9 and T10 had lower emission rates and did not differ from T2.

At Days 7 and 9, a correlation between liming and fertilization treatment was observed (Table 18). The most significant change was observed with T9Lime at Day 7. Prior to Day 7 T9Lime exhibited daily similar NH₃ emission rate compared to Control (T2). However, on Day 7, T9Lime emitted 10 times more NH₃ than the average emittance of T2, T2Lime, T9, T10, and T10Lime. This effect was even greater on Day 9, where T9 and T9Lime exhibited the greatest volatilization rate of all treatments. Also, on that date, T1, T3, T4, T5, T6, T7, and T8 (with or without lime) did not show any differences amongst each other, but still emitted more NH₃ than T2 and T10 (with or without lime).

At Day 11, the treatment that received the greatest rate of Formulation B (T10) started differentiating from the Control (T2), while T9 still had the greatest volatilization rate from all treatments. This trend was reversed at Day 15, when T10 had the greatest volatilization rate. From that day on, the magnitude of the NH₃ volatilization rate decreased over time for all treatments, but followed the general trend T10>T9>T1=T3=T4=T5=T6=T7=T8>T2, with no interaction between liming and fertilization, except for Day 19.

TABLE 18
Results from the analysis of variance for N—HN₃ emission rate

| | Day | | | | | | | | | | | |
|---|---|---|---|---|---|---|---|---|---|---|---|---|
| | 1 | 2 | 3 | 4 | 5 | 7 | 9 | 11 | 15 | 19 | 23 | 30 |
| Model | <0.0001 | <0.0001 | <0.0001 | <0.0001 | <0.0001 | <0.0001 | <0.0001 | <0.0001 | <0.0001 | <0.0001 | <0.0001 | <0.0001 |
| Liming | 0.0127 | 0.2389 | 0.0373 | 0.0733 | 0.6321 | 0.7501 | 0.7793 | 0.3728 | 0.814 | 0.0391 | 0.4232 | 0.2162 |
| Fertilizer | <0.0001 | <0.0001 | <0.0001 | <0.0001 | <0.0001 | <0.0001 | <0.0001 | <0.0001 | <0.0001 | <0.0001 | <0.0001 | <0.0001 |
| FxL | <0.0001 | 0.9168 | 0.6743 | 0.0557 | 0.703 | 0.002 | 0.0494 | 0.0931 | 0.1458 | 0.0213 | 0.0706 | 0.6911 |

### 2.4. Cumulative Volatilized N—NH₃

No effect of liming was observed on the cumulative amount of NH₃ released throughout the incubation, except for Day 1 (Table 19). Consequently, except for that day, these results (Table 20) describe the average cumulative amount of NH₃ volatilized from limed and non-limed experimental units of each treatment. The fact that liming affects the NH₃ volatilization rate (Section 2.3) but not the cumulative emissions shows that the effect of liming over that rate is compensated throughout time. This is to say that, for example, if T1Lime had a greater NH₃ emission rate than T1 at Day 1, and it exhibited a proportionally lower rate than T1 in subsequent days.

At Day 1, and as observed for the volatilization rate (Table 18), all treatments had the same NH₃ emission, except for T1Lime, which emitted 30 times more NH₃ than the average of the rest of the treatments (data not shown). At Day 2, the treated urea (T3 to T10) resulted in lower cumulative emissions compared to normal urea (T1) (Table 20), which in some cases (T4, T8, T9, and T10) did not differ from the unfertilized soil (T2). The trend at Day 3 was similar to that observed at Day 2, but T3 and T5 (Formulation C and Formulation D at their lowest rates) did not differ from the untreated urea (T1) and the treatments with Formulation B (T9 and T10) were the only ones that emitted the same cumulative amount of NH₃ as the Control (T2). At Days 4 and 5, only T6, T8, and T9 exhibited lower cumulative emissions than the untreated urea (T1), and T8 and T9 did not differ from the T2. However, at Day 7, the efficiency of T6 to reduce NH₃ emissions compared with T1 stopped being significant.

At Day 9, the cumulative NH₃ released by the treatment with Formulation B at the lowest rate (T9) started to differentiate from the Control (T2). By Day 15, even the treatment with the greatest rate of Formulation B (T10) started to exhibit greater accumulated NH₃ emissions compared to T2. From that day until Day 23, the general trend was: T1, T3, T4, T5, T6, T7, T8>T10>T9>T2. By the end of the experiment, only T10 had a lower cumulative emission compared to T1.

TABLE 19
Results from the analysis of variance for cumulative N—HN₃ emissions (mg N)

| | Day | | | | | | | | | | | |
|---|---|---|---|---|---|---|---|---|---|---|---|---|
| | 1 | 2 | 3 | 4 | 5 | 7 | 9 | 11 | 15 | 19 | 23 | 30 |
| Model | <0.0001 | <0.0001 | <0.0001 | <0.0001 | <0.0001 | <0.0001 | <0.0001 | <0.0001 | <0.0001 | <0.0001 | <0.0001 | <0.0001 |
| Liming | <0.0001 | <0.0001 | <0.0001 | <0.0001 | <0.0001 | <0.0001 | <0.0001 | <0.0001 | <0.0001 | <0.0001 | <0.0001 | <0.0001 |
| Fertilizer | 0.0126 | 0.0615 | 0.8867 | 0.4638 | 0.4109 | 0.3868 | 0.3325 | 0.2272 | 0.3152 | 0.6632 | 0.8012 | 0.9433 |
| FxL | <0.0001 | 0.4967 | 0.9619 | 0.5552 | 0.8582 | 0.7429 | 0.3672 | 0.5173 | 0.3065 | 0.4992 | 0.7112 | 0.8357 |

TABLE 20
Means comparison for the cumulative N—HN₃ (mg) released during a 30 days incubation experiment at each experimental unit

| | Day | | | | | | | | | | | | | | | | | | | | | |
|---|---|---|---|---|---|---|---|---|---|---|---|---|---|---|---|---|---|---|---|---|---|---|
| | 2** | | 3 | | 4 | | 5 | | 7 | | 9 | | 11 | | 15 | | 19 | | 23 | | 30 | |
| | mg N | | | | | | | | | | | | | | | | | | | | | |
| T1* | 59.6 | a | 103.3 | a | 126.8 | a | 150.8 | a | 181.0 | a | 207.8 | a | 233.6 | a | 274.3 | a | 305.7 | a | 333.8 | a | 364.2 | a |
| T2 | 1.5 | ef | 1.5 | f | 1.6 | c | 1.6 | c | 1.7 | b | 1.7 | c | 1.7 | c | 1.7 | d | 1.7 | d | 1.7 | d | 1.7 | c |
| T3 | 28.1 | b | 90.0 | abc | 118.3 | ab | 141.0 | ab | 170.3 | a | 194.6 | a | 222.2 | a | 263.2 | a | 296.4 | a | 321.6 | a | 347.4 | a |
| T4 | 12.9 | de | 73.5 | de | 108.3 | ab | 133.1 | ab | 165.6 | a | 193.3 | a | 219.9 | a | 263.2 | a | 297.9 | a | 326.8 | a | 353.4 | a |
| T5 | 32.8 | b | 94.5 | ab | 123.7 | a | 149.0 | ab | 180.9 | a | 206.1 | a | 231.7 | a | 272.7 | a | 304.8 | a | 332.8 | a | 358.4 | a |
| T16 | 15.7 | cd | 76.8 | cde | 101.3 | b | 130.2 | b | 164.1 | a | 191.3 | a | 216.9 | a | 259.4 | a | 295.7 | a | 323.6 | a | 352.9 | a |
| T7 | 27.2 | bc | 87.3 | bcd | 119.5 | ab | 141.7 | ab | 175.7 | a | 203.3 | a | 229.7 | a | 272.6 | a | 308.2 | a | 336.6 | a | 365.5 | a |
| T8 | 9.2 | def | 67.0 | e | 108.5 | ab | 133.0 | ab | 172.1 | a | 202.4 | a | 226.5 | a | 270.2 | a | 309.9 | a | 338.0 | a | 368.4 | a |
| T9 | 0.9 | f | 0.9 | f | 1.2 | c | 3.8 | c | 10.1 | b | 69.5 | b | 110.3 | b | 186.4 | b | 244.7 | b | 289.3 | b | 336.3 | ab |
| T10 | 0.4 | f | 0.4 | f | 0.5 | c | 0.6 | c | 1.6 | b | 3.0 | c | 16.3 | c | 111.8 | c | 191.3 | c | 250.8 | c | 319.1 | b |

*The presented data represents the average between the treatments that received lime and treatments without lime, since no effect of liming was observed from Day 2 to 30 (Table 19).
**Data from Day 1 is not presented in this Table, since at that day a significant liming × fertilizer treatment was observed. Results from Day 1 are discussed in the text.

### 2.5. Recovery of the Applied N

The percentage of the fertilizer-N recovered at the end of the experiment either as NH₃ or mineral N in the soil ranged from 65% to 92%. No effect of liming was observed on this variable. Contrarily, the treatment of the urea had a significant effect (p=0.0391). From the evaluated treatments, the recovery was greater at T4 and T8 as compared with T9 (Table 21). The differences observed in the recovery of the fertilizer-N can be due to losses of N by denitrification, immobilization of N in the microbial biomass, or by the accumulation of N in chemical forms that were unaccounted in the study (for example, as urea).

TABLE 21
Results from % of N in the fertilizer
recovered at the end of the experiment.

| | |
|---|---|
| Treatment | N recovered |

%

| | | |
|---|---|---|
| T4 | 85.1 | a |
| T8 | 84.7 | a |
| T5 | 84.5 | ab |
| T1 | 83.8 | ab |
| T6 | 82.8 | ab |
| T3 | 82.1 | ab |
| T7 | 81.5 | ab |
| T10 | 81.4 | ab |
| T9 | 76.9 | b |

### 3. Conclusions

From the evaluated treatments, only the application of Formulation B at a 14.0 L Mg⁻¹ rate decreased the cumulative amount of NH₃ volatilized during a 30-day incubation, as compared to the untreated urea. Considering the high rate at which Formulation B (14.0 L Mg⁻¹) volatilized NH₃ in late stages of incubation, if the period of incubation was extended this treatment would have equalled the cumulative volatilization of the other treatments. Still, in all cases, the treatment of urea resulted, at a certain point of the incubation, in a decrease of the rate of volatilization. This effect depended on the product, the rate, and the application of lime. Therefore, the use of the materials (depending on the product and rate) can be evaluated as strategy to favour the synchronization between N availability and plant demand, which limits possible N losses.

### 4. References

Bremner, J. M., & Keeney, D. R. (1965). Steam distillation methods for determination of ammonium, nitrate and nitrite. Analytica chimica acta, 32, 485-495.
Bouyoucos, G. J. (1936). Directions for making mechanical analyses of soils by the hydrometer method. Soil Science, 42(3), 225-230.
Cabrera, M. L., Kissel, D. E., & Bock, B. R. (1991). Urea hydrolysis in soil: Effects of urea concentration and soil pH. Soil Biology and Biochemistry, 23(12), 1121-1124.
Chapman, H. D. (1965). Cation-exchange capacity. Methods of Soil Analysis: Part 2 Chemical and Microbiological Properties, 9, 891-901.
Haby, V. A., Russelle, M. P., & Skogley, E. O. (1990). Testing soils for potassium, calcium, and magnesium. Soil testing and plant analysis, 3, 181-227.
Walkley, A., & Black, I. A. (1934). An examination of the Degtjareff method for determining soil organic matter, and a proposed modification of the chromic acid titration method. Soil Science, 37(1), 29-38.

1. A method of inhibiting urease enzyme activity and/or fertilizing soil, the method comprising applying a urease inhibitor composition to the soil, wherein the urease inhibitor composition comprises:
tert-butylhydroquinone in an amount of from about 0.1% to about 65% by weight based on the total weight of the composition; and
an organic solvent selected from the group consisting of a sulfoxide, an aromatic solvent, a green solvent, a safe solvent, and a combination thereof.

2. The composition of claim 1, wherein the organic solvent comprises dimethyl sulfoxide, xylene, or a combination thereof.

3. The method of claim 2, wherein dimethyl sulfoxide and xylene are present at a weight ratio of from about 1:2 to about 2:1.

4. The method of claim 1, wherein the urease inhibitor composition further comprises an additive component selected from the group consisting of an α,β-unsaturated carbonyl system-containing additive, an acid-containing additive, an ester-containing additive, an aromatic additive, a glycol-containing additive, and a combination thereof.

5. The method of claim 4, wherein the additive component is an α,β-unsaturated carbonyl system-containing additive selected from citral, mesityl oxide, α-amylcinnamaldehyde, coumarin, and a combination thereof.

6. The method of claim 4, wherein the additive component is an aromatic additive selected from butylated hydroxyanisole, eugenol, salicylaldehyde, acetophenone, methyl salicylate, and a combination thereof.

7. The method of claim 4, wherein the additive component is an acid-containing additive selected from itacoic acid, adipic acid, maleic acid, octanoic acid, ethyl maltol, ascorbic acid, levulinic acid, and a combination thereof.

8. The method of claim 4, wherein the additive component is an ester-containing additive selected from triethyl citrate, isobornyl acetate, propylene carbonate, ethyl lactate, and a combination thereof.

9. The method of claim 4, wherein the additive component is a glycol-containing additive selected from diethylene glycol monoethyl ether, ethylene glycol, monobutyl ether, and a combination thereof.

10. The method of claim 4, wherein tert-butylhydroquinone and the additive component are present in a weight ratio of from about 1:10 to about 10:1.

11. (canceled)

12. (canceled)

13. The method of claim 1, wherein at least about 50% of urease enzyme activity is being inhibited.

14. (canceled)

15. An agricultural composition comprising:
a urease inhibitor composition; and
a solid urea-containing fertilizer,
wherein the urease inhibitor composition comprises
tert-butylhydroquinone; and
an organic solvent selected from the group consisting of a sulfone, an aromatic solvent, a green solvent, a safe solvent, and a combination thereof,
wherein the urease inhibitor composition is present in an amount of from about 0.001% to about 10% by weight based on the total weight of the agricultural composition and
wherein the surface of the solid urea-containing fertilizer is coated with the urease inhibitor composition.

16. The agricultural composition of claim 15, wherein the solid urea-containing fertilizer is in the form of granules or prills.

17. (canceled)

18. (canceled)

19. The agricultural composition of claim 15, wherein the organic solvent comprises dimethyl sulfoxide, xylene, or a combination thereof.

20. The agricultural composition of claim 19, wherein dimethyl sulfoxide and xylene are present at a weight ratio of from about 1:2 to about 2:1.

21. The agricultural composition of claim 15, wherein the urease inhibitor composition further comprises an additive component selected from the group consisting of an α,β-unsaturated carbonyl system-containing additive, an acid-containing additive, an ester-containing additive, an aromatic additive, a glycol-containing additive.

22. The agricultural composition of claim 21, wherein the additive component is an α,β-unsaturated carbonyl system-containing additive selected from citral, mesityl oxide, α-amylcinnamaldehyde, coumarin, and a combination thereof, and/or an aromatic additive selected from butylated hydroxyanisole, eugenol, salicylaldehyde, acetophenone, methyl salicylate, and a combination thereof.

23. (canceled)

24. The agricultural composition of claim 21, wherein the additive component is an acid-containing additive selected from itacoic acid, adipic acid, maleic acid, octanoic acid, ethyl maltol, ascorbic acid, levulinic acid, and a combination thereof; and/or an ester-containing additive selected from triethyl citrate, isobornyl acetate, propylene carbonate, ethyl lactate, and a combination thereof; and/or a glycol-containing additive selected from diethylene glycol monoethyl ether, ethylene glycol, monobutyl ether, and a combination thereof.

25. (canceled)

26. (canceled)

27. The agricultural composition of claim 21, wherein tert-butylhydroquinone and the additive component are present in a weight ratio of from about 1:10 to about 10:1.

28. (canceled)

29. (canceled)

30. A method for preparing an agricultural composition of claim 15, the method comprising applying to the surface of the solid urea-containing fertilizer the urease inhibitor composition in the form of a liquid or dispersion, thereby coating the solid urea-containing fertilizer.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
